(19) United States
(12) Patent Application Publication
(10) Pub. No.: US 2026/0095977 A1
(43) Pub. Date: Apr. 2, 2026

(54) ELECTRONIC DEVICE AND METHOD OF PLACING EMERGENCY CALL

(71) Applicant: Samsung Electronics Co., Ltd., Suwon-si (KR)

(72) Inventors: Thien Trang DONG, Hanoi (VN); Thi Loan DAO, Hanoi (VN); Thi Dien DANG, Hanoi (VN); Ngoc Son VO, Hanoi (VN); Van Hai DUONG, Hanoi (VN)

(21) Appl. No.: 19/257,010

(22) Filed: Jul. 1, 2025

(30) Foreign Application Priority Data
Sep. 27, 2024 (KR) 10-2024-0131718

(51) Int. Cl. H04W 76/50; H04B 7/185; H04W 76/18

(52) U.S. Cl. CPC H04W 76/50; H04B 7/18539; H04B 7/1855; H04W 76/18

(57) ABSTRACT

A method of operating an electronic device includes, based on whether non-terrestrial network (NTN) information for establishing an NTN connection at a current location of the electronic device is valid, obtaining the NTN information from an external electronic device. The method includes, when a TN fails to support an emergency call, based on the NTN information, placing the emergency call through an NTN.

### CROSS-REFERENCE TO RELATED APPLICATION

This application is based on and claims priority under 35 U.S.C. § 119 to Korean Patent Application No. 10-2024-0131718, filed on Sep. 27, 2024, in the Korean Intellectual Property Office, the disclosure of which is incorporated by reference herein in its entirety.

### BACKGROUND

### 1. Field

The disclosure relates to an electronic device and a method of placing an emergency call.

### 2. Description of Related Art

Looking back at the development process through the successive generations of wireless communication, technology has been developed primarily for human-targeted services such as voice, multimedia, and data. Connected devices, which are experiencing an explosive increase after the commercialization of 5th-generation (5G) communication systems, are expected to be connected to communication networks. Examples of objects connected to a network include vehicles, robots, drones, home appliances, displays, smart sensors installed in various infrastructures, construction equipment, factory equipment, and the like. Mobile devices are expected to evolve into various form factors such as augmented reality glasses, virtual reality headsets, and holographic devices. In the 6G era, efforts are being made to develop improved 6G communication systems to connect hundreds of billions of devices and objects and provide various services. For this reason, 6G communication systems are called Beyond 5G systems.

The maximum transmission speed in the 6G communication systems, which is expected to be realized around 2030, is tera (e.g., 1,000 giga) bit per second (bps), and the wireless delay time is 100 microseconds (μsec). In other words, the transmission speed in the 6G communication systems is 50 times faster compared to the 5G communication systems, and the wireless delay time is reduced to one-tenth.

To achieve these high data rates and ultra-low latency, the 6G communication systems are being considered for implementation in terahertz bands (e.g., from 95 gigahertz (GHz) to 3 terahertz (THz) band). In terahertz bands, the importance of technology that may guarantee signal reach, or coverage, is expected to increase due to more severe path loss and atmospheric absorption phenomena compared to millimeter wave (mmWave) bands introduced in 5G. Key technology to ensure coverage, such as radio frequency (RF) elements, antennas, novel waveforms that are superior to orthogonal frequency division multiplexing (OFDM) in terms of coverage, beamforming, and multiple antenna transmission technology such as massive multiple-input and multiple-output (MIMO), full dimensional MIMO (FD-MIMO), array antennas, and large scale antennas have to be developed. In addition, new technology such as metamaterial-based lenses and antennas, high-dimensional spatial multiplexing technology using orbital angular momentum (OAM), and reconfigurable intelligent surfaces (RIS) is being discussed to improve the coverage of terahertz band signals.

Next-generation mobile communication systems, referred to as 5G, Beyond 5G, or 6G described above, are considering utilizing satellite networks to overcome the physical limitations of existing mobile communication and expand the range of connectivity from terrestrial to global, and various communication techniques utilizing satellite networks are being designed.

The above information may be presented as the related art to help with the understanding of the disclosure. No assertion or determination is made to whether any of the above description is applicable as the prior art related to the present disclosure.

### SUMMARY

According to an example embodiment, a method of operating an electronic device includes: based on whether non-terrestrial network (NTN) information for establishing an NTN connection at a current location of the electronic device is valid, obtaining the NTN information from an external electronic device; and based on a terrestrial network (TN) failing to support an emergency call, based on the NTN information, placing the emergency call through an NTN.

According to an example embodiment, an electronic device includes: a wireless communication module, comprising communication circuitry; at least one processor including processing circuitry; memory storing instructions; wherein at least one processor, individually or collectively, is configured to execute the instructions and to cause the electronic device to: based on whether NTN information for establishing an NTN connection at a current location of the electronic device is valid, obtain the NTN information from an external electronic device; and based on a TN failing to support an emergency call, based on the NTN information, place the emergency call through an NTN.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a diagram illustrating an example structure of a non-terrestrial network (NTN) according to various embodiments;

FIG. 2 is a diagram illustrating an example of applying an NTN to a new radio (NR) system, according to various embodiments;

FIGS. 3A and 3B are diagrams illustrating an example of an earth-moving cell and an earth-fixed cell in an NTN, according to various embodiments;

FIG. 4A is a diagram illustrating an example system for placing an emergency call through an NTN, according to various embodiments;

FIG. 4B is a block diagram illustrating an example configuration of an electronic device according to various embodiments;

FIG. 5 is a flowchart illustrating an example method of searching for an NTN, according to various embodiments;

FIG. 6 is a flowchart illustrating an example method of placing an emergency call through an NTN, according to various embodiments;

FIG. 7 is a flowchart illustrating an example method of searching for an NTN for placing an emergency call, according to various embodiments;

FIG. 8 is a flowchart illustrating an example method of verifying validity of NTN information in order to request NTN information from an external electronic device, according to various embodiments;

FIG. 9 is a flowchart illustrating an example method of requesting NTN information from an external electronic device, according to various embodiments;

FIGS. 10A and 10B include a signal flow diagram and a diagram illustrating an example method of transmitting and receiving data between an electronic device and a second external electronic device, according to various embodiments;

FIG. 11A is a flowchart illustrating an example operation in which a second external electronic device outputs NTN information to an electronic device, according to various embodiments;

FIG. 11B is a flowchart illustrating an example operation in which the electronic device obtains the NTN information from the second external electronic device and updates memory, according to various embodiments;

FIG. 12 is a signal flow diagram illustrating an example method of transmitting and receiving data between an electronic device and a first external electronic device, according to various embodiments;

FIG. 13 is a signal flow diagram illustrating an example method of updating NTN information, according to various embodiments;

FIGS. 14A and 14B are flowcharts illustrating an example method of updating the NTN information illustrated in FIG. 13 through operations of an electronic device and a first external electronic device according to various embodiments;

FIG. 15 is a flowchart illustrating an example method of placing an emergency call when an electronic device obtains NTN information from an external electronic device, according to various embodiments;

FIG. 16 is a diagram illustrating an example of a screen displaying an NTN information request and an NTN search, according to various embodiments; and

FIG. 17 is a block diagram illustrating an example electronic device in a network environment, according to various embodiments.

### DETAILED DESCRIPTION

Hereinafter, various example embodiments are described in greater detail with reference to the accompanying drawings. When describing the various example embodiments with reference to the accompanying drawings, like reference numerals refer to like elements and a repeated description related thereto may not be provided.

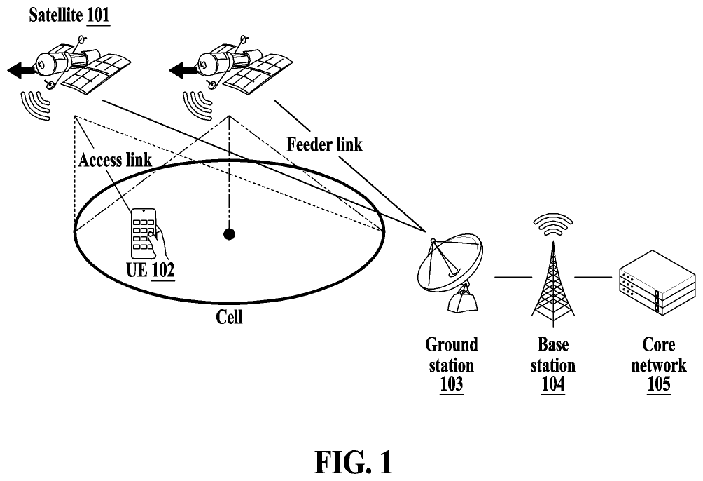

FIG. 1 is a diagram illustrating an example structure of a non-terrestrial network (NTN) according to various embodiments.

Referring to FIG. 1, according to an embodiment, an NTN may include a satellite 101, a terminal 102, a ground station 103, a base station 104, or a core network (CN) 105. The NTN described in the present disclosure is not limited to the configuration illustrated in FIG. 1 and may further include a network entity or a network node.

According to an embodiment, the satellite 101 may be a transparent satellite or a regenerative satellite. The transparent satellite and the regenerative satellite are distinguished based on satellite functions. The transparent satellite may be a bent-pipe type satellite that may perform a function of amplifying and forwarding a signal transmitted from a TN. For example, the transparent satellite may act as a kind of relay node. The transparent satellite may not use an inter-satellite link (ISL). The regenerative satellite may go beyond a simple relay node to perform computation, processing, and decoding of a radio wave signal. The regenerative satellite may perform a function of a distributed unit (DU) or a central unit (CU) in new radio (NR) and may also perform a function of an independent base station. The regenerative satellite may also perform multi-hop communication between satellites using an ISL.

According to an embodiment, a connection between the terminal 102 and the satellite 101 may be referred to as an access link, and a connection between the satellite 101 and the ground station 103 may be referred to as a feeder link. The feeder link may be a connection between the satellite 101 and the base station 104. When the ground station 103 and the base station 104 are combined into one, the feeder link may also be a connection between the satellite 101 and the combined ground station 103 and base station 104. The CN 105 may include a user plane function (UPF) and a network function (NF) of NR or a satellite control server in satellite communication.

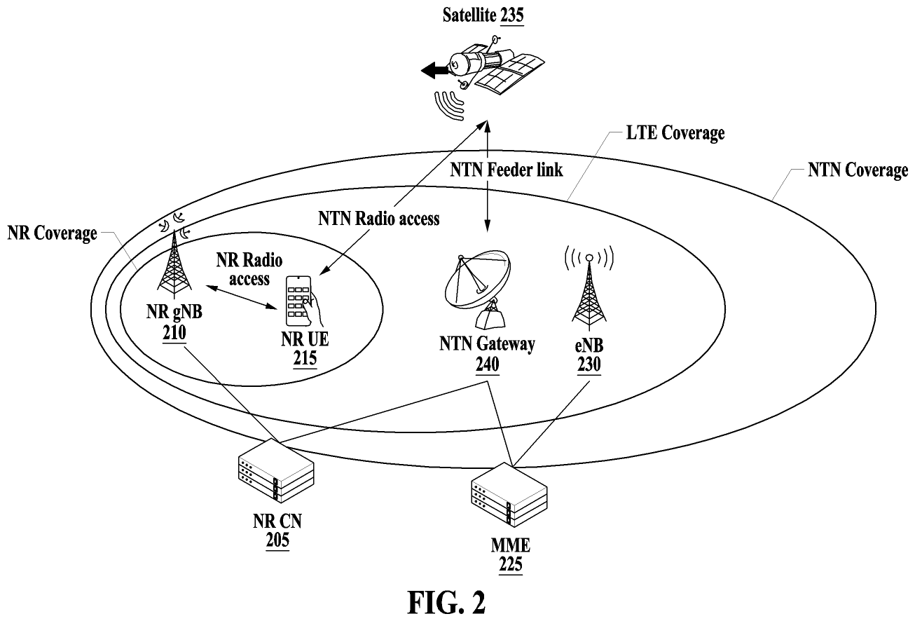

According to an embodiment, an NTN may be applied to an NR system. This is described in greater detail below with reference to FIG. 2.

FIG. 2 is a diagram illustrating an example of applying an NTN to an NR system, according to various embodiments.

Referring to FIG. 2, according to an embodiment, an NTN may include an NR node B (hereinafter, referred to as NR gNB or NR base station) 210, an NR CN 205, a satellite 235, and an NTN gateway 240. NR user equipment (UE) (or terminal) 215 may access an external network via the NR gNB 210 and the NR CN 205. When accessing an NTN, the NR UE 215 may transmit and receive data to and from the satellite 235. The satellite 235 may transmit and receive data to and from the NTN gateway 240. The NTN gateway may be connected to the NR CN 205 or a mobility management entity (MME) 225. Although not shown in FIG. 2, the NTN gateway may also be connected to the NR gNB 210.

According to an embodiment, the NR gNB 210 may correspond to an evolved NB (eNB) of an existing long-term evolution (LTE) system. The NR gNB may be connected to the NR UE 215 via a wireless channel and may provide a superior service than an existing NB. In a next-generation mobile communication system, all user traffic may be served through a shared channel. Therefore, a device that collects state information such as buffer states, available transmission power states, and channel states of UEs and performs scheduling may be required, and the NR gNB 210 may be in charge of this. One NR gNB 210 may control a plurality of cells. In the next-generation mobile communication system, a bandwidth that is greater than or equal to the current maximum bandwidth may be applied to implement ultra-high-speed data transmission compared to the current LTE. Furthermore, beamforming technology may be additionally applied using orthogonal frequency division multiplexing (OFDM) as wireless access technology. In addition, an adaptive modulation and coding (AMC) scheme that determines a modulation scheme and a channel coding rate according to a channel state of a terminal may be applied.

According to an embodiment, the NR CN 205 may perform functions such as mobility support, bearer establishment, and quality of service (QoS) establishment. The NR CN 205 may be a device that handles various control functions as well as mobility management functions for a terminal and may be connected to a plurality of base stations. The next-generation mobile communication system may also be interconnected with the existing LTE system, and the NR CN 205 may be connected to the MME 225 through a network interface. The MME 225 may be connected to an existing base station, an eNB 230.

According to an embodiment, the NTN described above is only an example of a communication system to which the present disclosure may be applied, and the present disclosure is not limited thereto. The present disclosure may also be applied to a communication system having different components than the NTN described above.

According to an embodiment, the altitudes of satellites that may be used in the NTN may vary. The types of satellites that may be used may be divided into geostationary (GEO) satellites and mobile satellites. Mobile satellites may be divided into low earth orbit (LEO) satellites and middle earth orbit (MEO) satellites depending on an orbital altitude. A GEO satellite may be a satellite that flies in a geostationary orbit at an altitude of about 36,000 kilometers (km). The geostationary orbit is the same as the rotation period of the Earth, so the GEO satellite may appear to be stationary at one point in the sky when viewed from the surface of the Earth. When communication is established with the GEO satellite due to the high satellite altitude, a radio wave arrival signal may be relatively weaker compared to a TN due to a path loss, and the performance of the communication via a wireless signal may also be low. The round trip time between a satellite and a device and a terminal on the ground may be relatively long (approximately 500 milliseconds (ms)). LEO and MEO satellites exist at lower altitudes than GEO satellites, so the path loss is low, and wireless signals of the LEO and MEO satellites may be relatively stronger. Still, compared to the TN, the path loss may be greater, and the wireless signals may be weaker. Additionally, the LEO and MEO satellites may move at very high speeds (about 7.56 km for LEO) relative to the surface of the Earth, unlike GEO satellites.

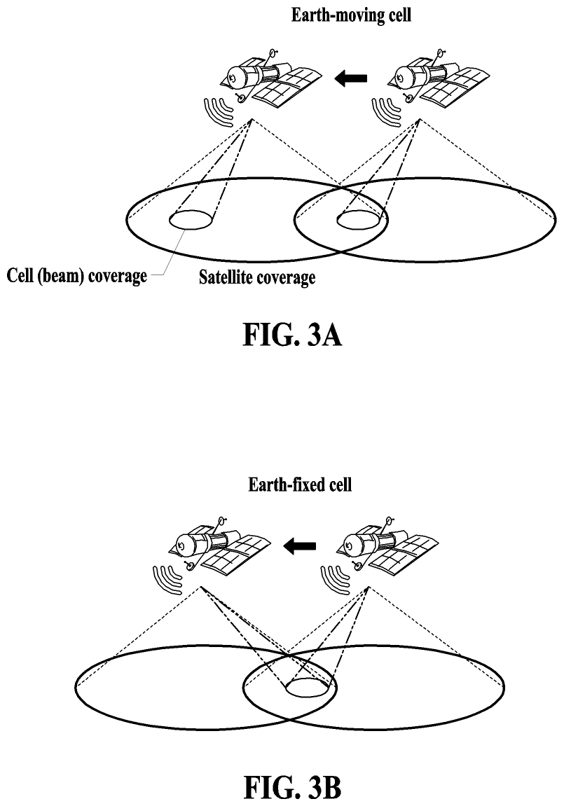

According to an embodiment, in an NTN, a satellite cell, which may include a unit that manages a terminal through a spot beam emitted from a satellite, may be formed. Because an LEO satellite moves in a predetermined orbit at a very high speed, satellite coverage that allows a satellite to communicate with a terminal may also move along with the satellite. Therefore, how a satellite cell is operated may vary depending on how the satellite cell is configured. According to an embodiment of the present disclosure, a method of configuring a satellite cell may be classified into an earth-moving cell and an earth-fixed cell. FIG. 3A is a diagram illustrating an example earth-moving cell. FIG. 3B is a diagram illustrating an example earth-fixed cell. An earth-moving cell may be a cell in which a satellite cell has the same mobility as a satellite moves and may be used in a satellite structure in which the antenna of the satellite does not steer but is always fixed in a direction perpendicular to the horizon. An earth-fixed cell may be formed at a designated location even when a satellite moves at a high speed when a predetermined region on the ground is designated as a satellite cell and the satellite adjusts the angle of a spot beam to fix the spot beam at the designated location. In this case, the beam angle of the satellite forming the spot beam may be adjusted mechanically or electronically. The earth-fixed cell have the advantage of being able to alleviate a phenomenon that may occur due to the high mobility of a satellite, since the time it takes for one satellite to form a cell is relatively longer than that of the earth-moving cell.

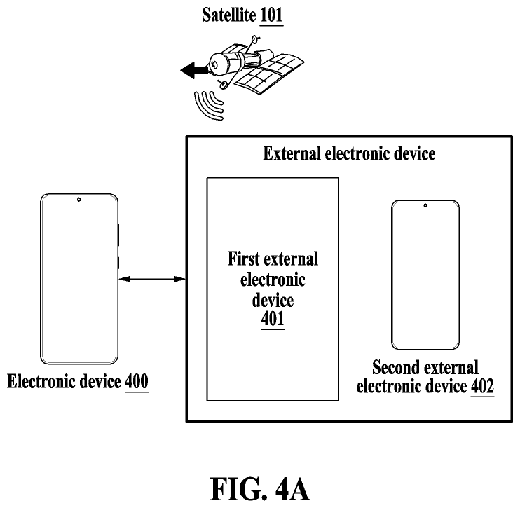

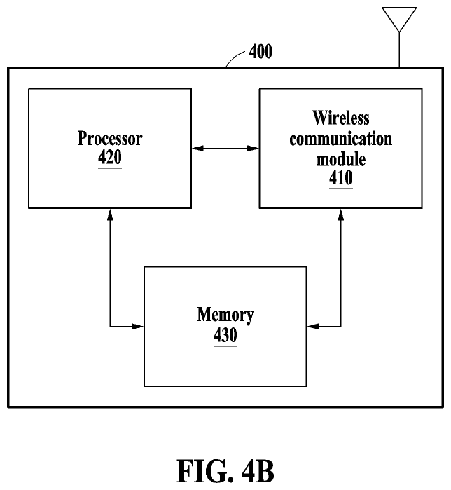

FIG. 4A is a diagram illustrating an example system for placing an emergency call through an NTN, according to various embodiments.

Referring to FIG. 4A, according to an embodiment, an electronic device 400 (e.g., the terminal 102 of FIG. 1) may form an NTN with a satellite (e.g., the satellite 101 of FIG. 1). When the electronic device 400 may not place an emergency call through a TN (e.g., a cellular network and/or wireless-fidelity (Wi-Fi) network), the electronic device 400 may place an emergency call through the NTN formed with the satellite 101.

According to an embodiment, in order for the electronic device 400 to form the NTN with the satellite 101, NTN information for establishing an NTN connection at the current location (e.g., a first location) of the electronic device 400 may be required. When the electronic device 400 does not have the NTN information at the first location, the electronic device 400 may not form an NTN with the satellite 101 at the first location.

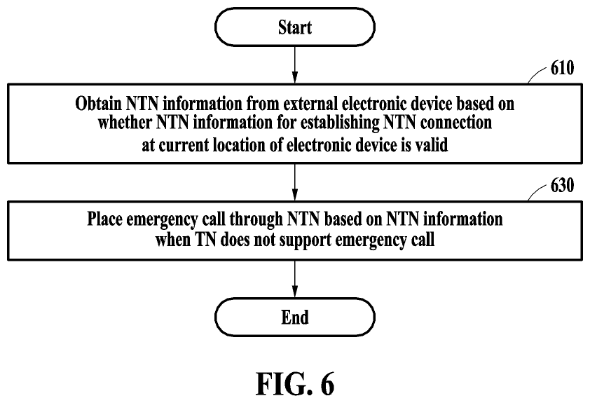

According to an embodiment, when the NTN information at the first location is absent, the electronic device 400 may request NTN information from an external electronic device to form an NTN. The external electronic device may include a first external electronic device 401 and/or a second external electronic device 402. The first external electronic device 401 may include a server that is responsible for supporting (e.g., storing and/or providing NTN information) an NTN connection. The second external electronic device 402 may be a user terminal. The first external electronic device 401 and the second external electronic device 402 are described in greater detail below with reference to FIG. 6.

According to an embodiment, the electronic device 400 may obtain NTN information from the external electronic device. The electronic device 400 may form an NTN with the satellite 101 based on the obtained NTN information. Even when the electronic device 400 may not place an emergency call through the TN, the electronic device 400 may place an emergency call through the NTN formed with the satellite 101.

FIG. 4B is a block diagram illustrating an example configuration of the electronic device according to various embodiments.

Referring to FIG. 4B, the electronic device 400 (e.g., the terminal 102 of FIG. 1) may include a wireless communication module (e.g., including communication circuitry) 410, a processor (e.g., including processing circuitry) 420, and memory 430.

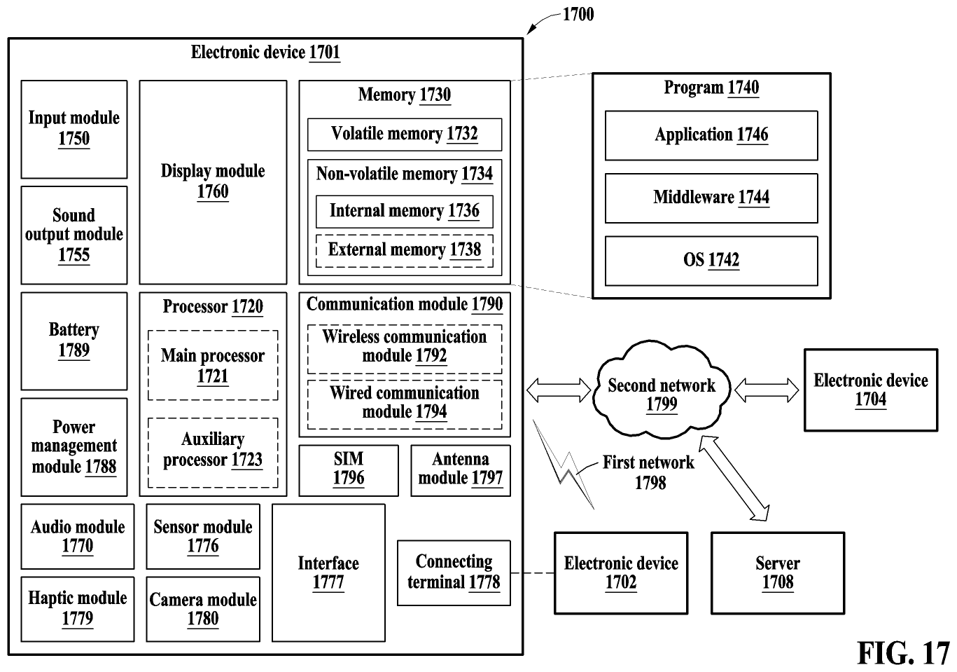

The wireless communication module 410 may include various communication circuitry and be configured to transmit and receive a wireless signal. The wireless communication module 410 may include a Wi-Fi chipset. The wireless communication module 410 may support multiple bands of 2.4 gigahertz (GHz), 5 GHz, and/or 6 GHz. The wireless communication module 410 may support a hardware (HW) function and/or a software (SW) function for establishing an NTN connection. An NTN processor 420 may be operatively connected to the wireless communication module 410. The memory 430 may be electrically connected to the processor 420 and store one or more instructions executable by the processor 420. The electronic device 400 may correspond to an electronic device (e.g., an electronic device 1701 of FIG. 17) described in greater detail below with reference to FIG. 17. The repeated descriptions provided with reference to FIG. 17 are not provided here. Operations performed by the electronic device 400 may include operations performed by the wireless communication module 410 and operations performed by the processor 420 through the wireless communication module 410.

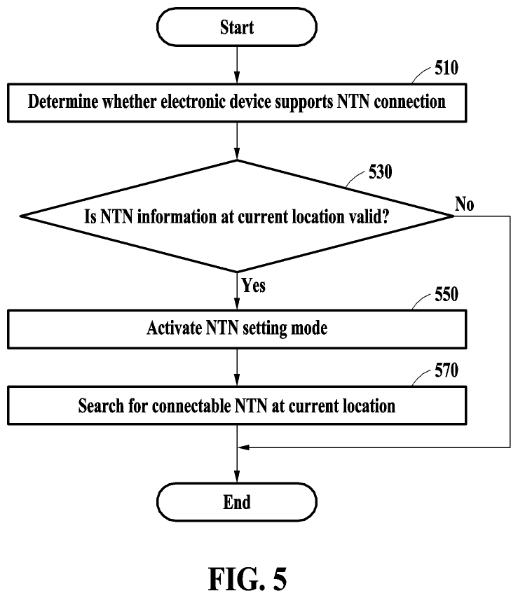

According to an embodiment, the memory 430 may include one or more memories. The instructions stored in the memory 430 may be stored in one memory. The instructions stored in the memory 430 may be divided and stored in a plurality of memories. The instructions stored in the memory 430 may be executed by the processor 420 and cause the electronic device 400 to perform and/or control the operations of the electronic device (e.g., the terminal 102) described with reference to FIGS. 1 to 4A and operations of the electronic device 400 described with reference to FIGS. 5 to 17.

According to an embodiment, the processor 420 may include various processing circuitry and be implemented as a system on chip (SoC) or circuitry (e.g., processing circuitry) such as an integrated circuit (IC). The processor 420 may include one or more processors. For example, the processor 420 may include a combination of one or more processors, such as a central processing unit (CPU), a graphics processing unit (GPU), a micro processing unit (MPU), an application processor (AP), and a communication processor (CP). The CP may be inside or outside the wireless communication module 410. Thus, the processor 420 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The instructions stored in the memory 430 may be executed by the processor and cause the electronic device 400 to perform and/or control the operations of the electronic device (e.g., the terminal 102) described with reference to FIGS. 1 to 3 and the operations of the electronic device 400 described with reference to FIGS. 5 to 17. The instructions stored in the memory 430 may be executed by a plurality of processors and cause the electronic device 400 to perform and/or control the operations of the electronic device (e.g., the terminal 102) described with reference to FIGS. 1 to 3 and the operations of the electronic device 400 described with reference to FIGS. 5 to 17.

FIG. 5 is a flowchart illustrating an example method of searching for an NTN, according to various embodiments.

Referring to FIG. 5, operations 510 to 570 may be performed sequentially but not necessarily. For example, operations 510 to 570 may be performed in different orders, and at least two operations may be performed in parallel.

In operation 510, an electronic device (e.g., the terminal 102 of FIG. 1 and/or the electronic device 400 of FIG. 4A) may determine whether the electronic device supports an NTN connection. The electronic device 400 may need to provide an HW function and/or an SW function for establishing an NTN connection to support an NTN connection. For example, the electronic device 400 may include an antenna and/or a radio frequency (RF) module. The antenna and/or the RF module may receive a satellite signal transmitted and received over a different frequency band than a TN. The antenna and/or the RF module may be implemented inside a wireless communication module (e.g., the wireless communication module 410 of FIG. 4A) of the electronic device 400 or outside the wireless communication module 410. For example, the electronic device 400 may support an NTN-dedicated protocol. The wireless communication module 410 may access an NTN through the NTN-dedicated protocol and communicate with a satellite (e.g., the satellite 101 of FIG. 1).

According to an embodiment, when supporting an NTN connection, the electronic device 400 may have existing NTN information. The success or failure of the connection between the electronic device 400 and the NTN at the current location of the electronic device 400 may be determined based on the validity of the existing NTN information. That is, the validity of the existing NTN information is important for establishing an NTN connection, so this is described below.

In operation 530, the electronic device 400 may determine whether the NTN information at the current location is valid. For example, in order for the electronic device 400 to communicate with the satellite 101 at a first location, NTN information for the first location may be required. In this case, the location of the electronic device 400 may be changed from the first location to a second location. The electronic device 400 may not communicate with the satellite 101 at the second location using the NTN information for the first location. For example, the electronic device 400 may need NTN information for the second location depending on a change in the location (e.g., the change from the first location to the second location). A case in which NTN information at the current location is valid may include a case in which the NTN information at the current location is present in the electronic device 400 and the validity period of the NTN information does not expire. On the other hand, a case in which the NTN information at the current location is invalid include a case in which the NTN information at the current location is absent from the electronic device 400 or the validity period of the NTN information expires even when the NTN information is present. For example, the NTN information at the current location may not be stored in memory (e.g., the memory 430 of FIG. 4A) included in the electronic device 400 and/or an embedded subscriber identity module (eSIM) (not shown) included in the electronic device 400. In this case, the NTN information may be invalid. For example, the NTN information at the current location may be stored in the memory 430 included in the electronic device 400 and/or the eSIM included in the electronic device 400. In this case, when the validity period of the NTN information does not expire, the NTN information may be valid. On the other hand, when the validity period of the NTN information expires, the NTN information may be invalid even when the NTN information at the current location is stored in the memory 430 included in the electronic device 400 and/or the eSIM included in the electronic device 400.

According to an embodiment, the existing NTN information may be invalid for establishing an NTN connection at the current location of the electronic device 400. The NTN connection may require different information depending on the location of the electronic device 400. For example, the electronic device 400 may be located at the first location and attempting to establish an NTN connection at the first location. When the existing NTN information is not the NTN information for the first location but the NTN information for the second location (e.g., a location different from the first location), an NTN connection may not be established at the first location based on the existing NTN information. In addition, even when the validity period of the existing NTN information expires, an NTN connection may not be established at the first location based on the existing NTN information. That is, the validity of the existing NTN information may be determined depending on whether the existing NTN information is the NTN information at the current location of the electronic device 400 and/or whether the validity period of the existing NTN information expires.

According to an embodiment, the electronic device 400 may perform operation 550 when the NTN information at the current location is valid. When the NTN information at the current location is invalid, the electronic device 400 may terminate the operation.

In operation 550, the electronic device 400 may activate an NTN setting mode. The NTN setting mode may be a state in which an NTN connection is being prepared. For example, in the NTN setting mode, based on the NTN information at the current location, the electronic device 400 may activate all relevant settings to scan for an NTN and attempt to establish a connection. The electronic device 400 may perform search (or scan) and connection procedures necessary to increase the likelihood of NTN connection in response to additional power consumption resulting from an NTN connection.

In operation 570, the electronic device 400 may search for a connectable NTN at the current location. The electronic device 400 may search (or scan) for an NTN according to the activation of the NTN setting mode.

According to an embodiment, as in operations 510 to 570, when the NTN information at the current location is valid (e.g., when the NTN information at the current location is present and the validity period of the NTN information does not expire), the electronic device 400 may search for an NTN at the current location. For example, when NTN information at a predetermined (e.g., specified) location is invalid, the electronic device 400 may not search for an NTN at the predetermined location. There may be a situation in which an emergency call is required to be placed but may not be placed through a TN (e.g., a cellular network and/or a Wi-Fi network). In this case, when NTN information for a corresponding location is absent from the electronic device 400, there may be an issue in that an attempt to establish an NTN connection may not be made even when an emergency call may be placed through an NTN. To address the above issue, when NTN information is invalid, the electronic device 400 may attempt to obtain NTN information through an external electronic device (e.g., the first external electronic device 401 of FIG. 4A and/or the second external electronic device 402 of FIG. 4A). This is described in greater detail below.

FIG. 6 is a flowchart illustrating an example method of placing an emergency call through an NTN, according to various embodiments.

Referring to FIG. 6, operations 610 and 630 may be performed sequentially but not necessarily. For example, operations 610 and 630 may be performed in different orders, and at least two operations may be performed in parallel.

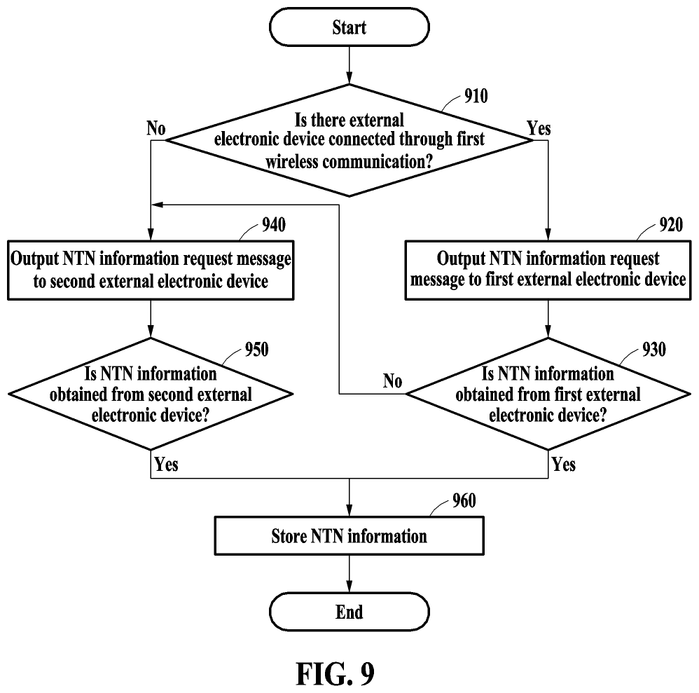

In operation 610, an electronic device (e.g., the terminal 102 of FIG. 1 and/or the electronic device 400 of FIG. 4A) may obtain NTN information from an external electronic device (e.g., the first external electronic device 401 of FIG. 4A and/or the second external electronic device 402 of FIG. 4A) based on whether NTN information for establishing an NTN connection at the current location of the electronic device 400 is valid. When the NTN information for the current location is valid, the electronic device 400 may not need to obtain NTN information again from the external electronic device. On the other hand, when the NTN information for the current location is invalid, the electronic device 400 may request NTN information from the external electronic device to obtain the NTN information from the external electronic device. A method in which the electronic device 400 outputs a message related to a request for NTN information to an external electronic device is described in greater detail below with reference to FIG. 9.

According to an embodiment, the external electronic device may be distinguished based on a wireless communication scheme by which a connection is established with the electronic device 400. A first external electronic device (e.g., the first external electronic device 401 of FIG. 4A) may be a device that is connected to the electronic device 400 through a first wireless communication scheme. A second external electronic device (e.g., the second external electronic device 402 of FIG. 4A) may be a device that is connected to the electronic device 400 through a second wireless communication scheme. The first wireless communication scheme may be a communication scheme having a longer communication distance than the second wireless communication scheme. For example, the first wireless communication scheme may include the Internet (e.g., performing data communication through a first wireless communication protocol (e.g., Internet protocol (IP)) and/or a transmission control protocol (TCP)). The second wireless communication scheme (e.g., performing data communication through a second wireless communication protocol) may include Bluetooth low energy (BLE), Wi-Fi Direct, and/or Nearby Share (e.g., a wireless communication scheme combining Bluetooth, Wi-Fi Direct, and near field communication (NFC)). The second external electronic device 402 may be closer to the electronic device 400 than the first external electronic device 401. The second external electronic device 402 may be located near the electronic device 400 (e.g., within a predetermined range of the electronic device 400).

According to an embodiment, the first external electronic device 401 may be a server responsible for supporting (e.g., storing and/or providing NTN information) an NTN connection. The first external electronic device 401 may be a public server (e.g., a server operated by a government or public institution) or a private server (e.g., a server operated by a private company (e.g., a predetermined telecommunication company).

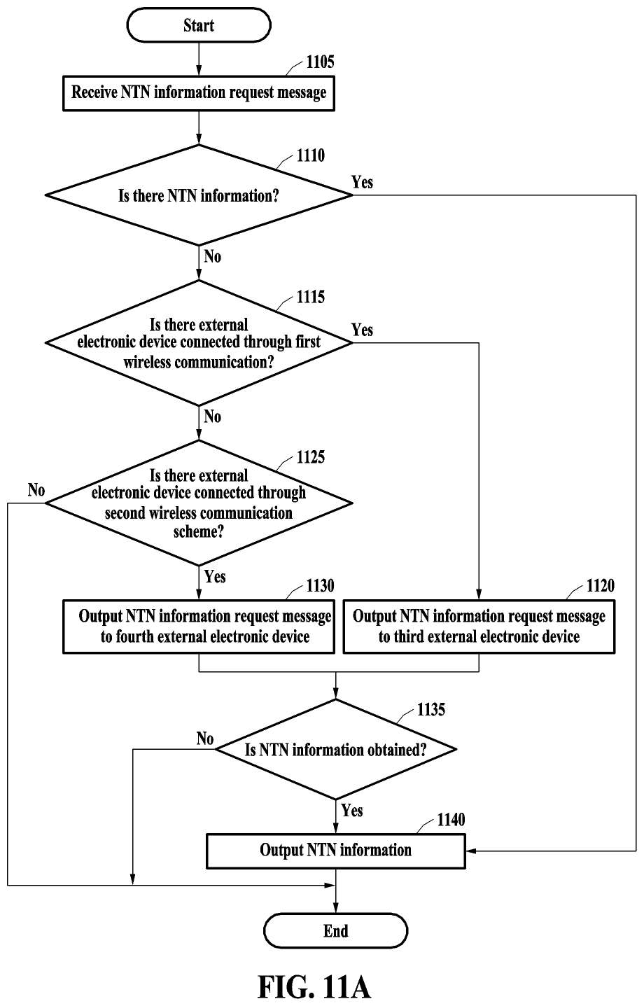

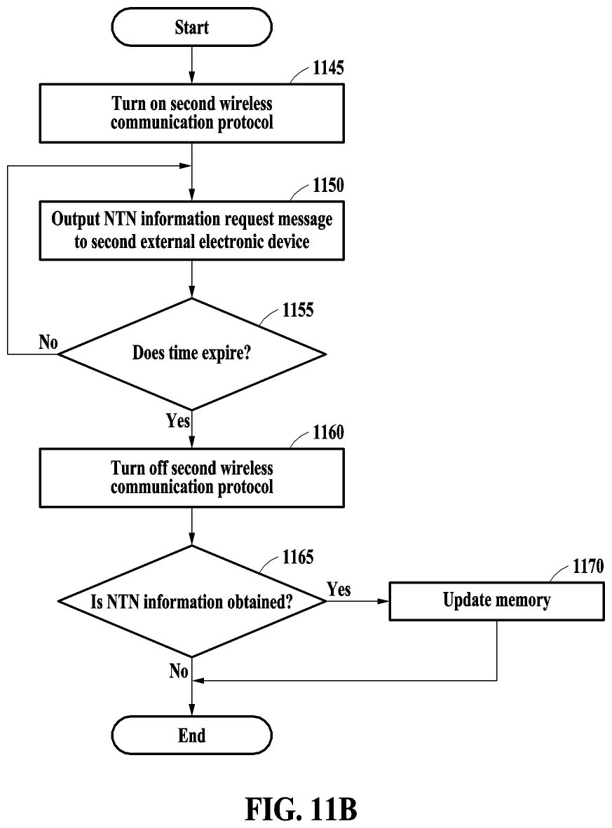

According to an embodiment, the second external electronic device 402 may be a user terminal such as the electronic device 400. The second external electronic device 402 may store and/or provide NTN information. However, when NTN information is not stored in the second external electronic device 402, the second external electronic device 402 may request NTN information from another external electronic device (e.g., a third external electronic device and/or a fourth external electronic device) and provide the NTN information to the electronic device 400. This is described in greater detail below with reference to FIG. 11A.

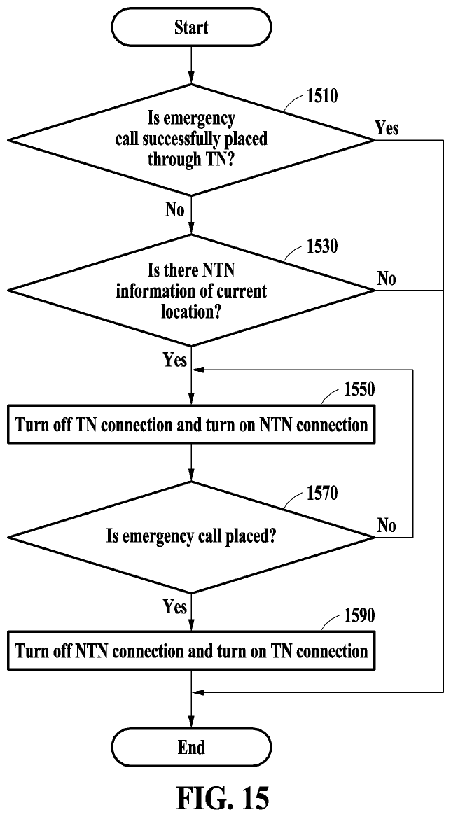

In operation 630, when a TN does not support an emergency call, the electronic device 400 may place an emergency call through an NTN based on the NTN information. Based on the NTN information, the electronic device 400 may search for an NTN according to a priority order related to an NTN connection. This is described in greater detail below with reference to FIG. 15.

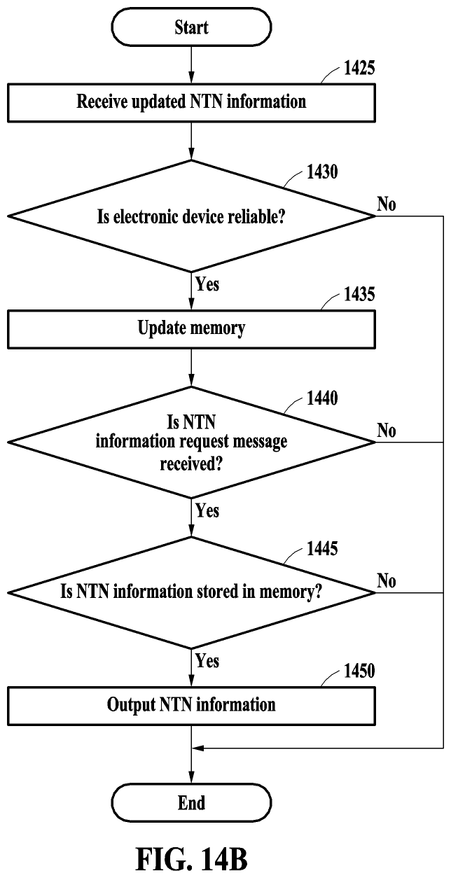

According to an embodiment, the electronic device 400 may successfully place an emergency call through the NTN information obtained (e.g., received) from the external electronic device (e.g., the first external electronic device 401 and/or the second external electronic device 402). When successfully placing an emergency call, the electronic device 400 may update the NTN information. The electronic device 400 may share the updated NTN information with the external electronic device. This is described in greater detail below with reference to FIGS. 14A and 14B.

According to an embodiment, when the TN supports an emergency call, the electronic device 400 may place an emergency call through the TN. For example, when a cellular network supports an emergency call at the current location, the electronic device 400 may place an emergency call through the cellular network. In this case, the electronic device 400 may immediately place an emergency call through the cellular network without performing operation 610.

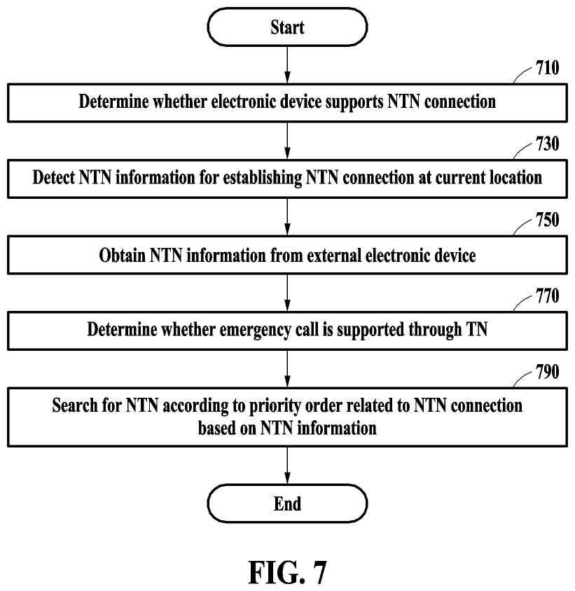

FIG. 7 is a flowchart illustrating an example method of searching for an NTN for placing an emergency call, according to various embodiments.

Referring to FIG. 7, operations 710 to 790 may be performed sequentially but not necessarily. For example, operations 710 to 790 may be performed in different orders, and at least two operations may be performed in parallel.

In operation 710, an electronic device (e.g., the terminal 102 of FIG. 1 and/or the electronic device 400 of FIG. 4A) may determine whether the electronic device 400 supports an NTN connection. The electronic device 400 may be required to provide an HW function and/or an SW function for establishing an NTN connection to support an NTN connection. This is described in detail in operation 510 of FIG. 5, and any duplicate description is omitted.

According to an embodiment, when supporting an NTN connection, the electronic device 400 may perform operation 730. When the electronic device 400 does not support an NTN connection, an emergency call through an NTN connection may not be placed by the electronic device 400, so a description thereof is omitted.

In operation 730, the electronic device 400 may detect NTN information (e.g., NTN information for the current location and/or NTN information at the current location) for establishing an NTN connection at the current location. The electronic device 400 may detect whether NTN information for the current location is valid. When the NTN information for the current location is invalid, the electronic device 400 may perform operation 750. When the NTN information for the current location is valid, the electronic device 400 may not need to request NTN information from an external electronic device.

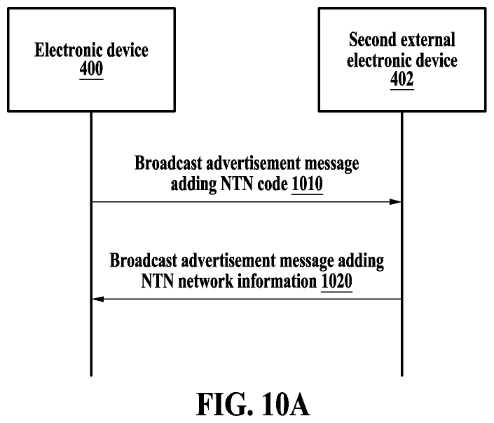

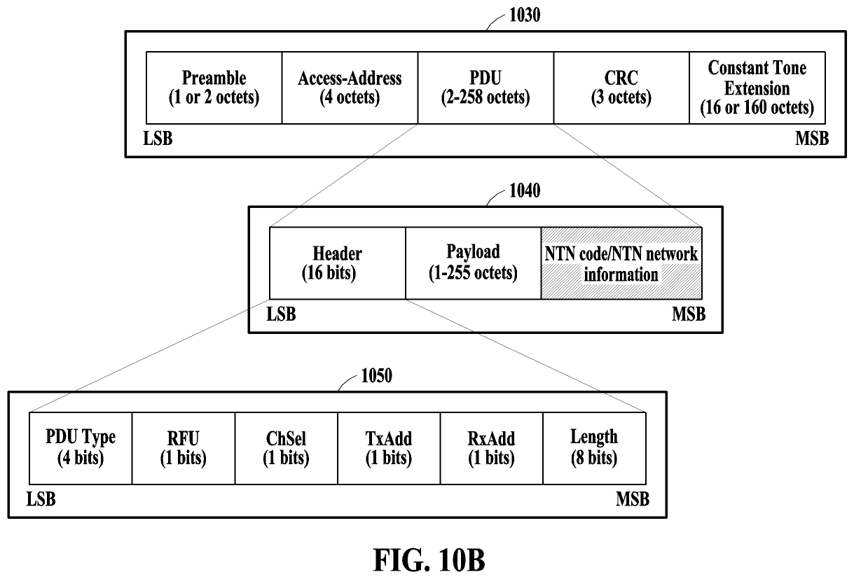

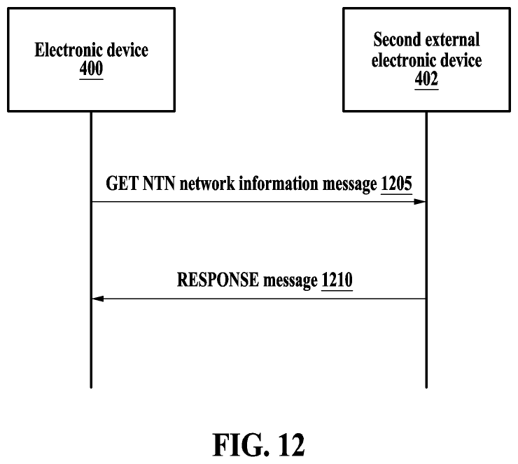

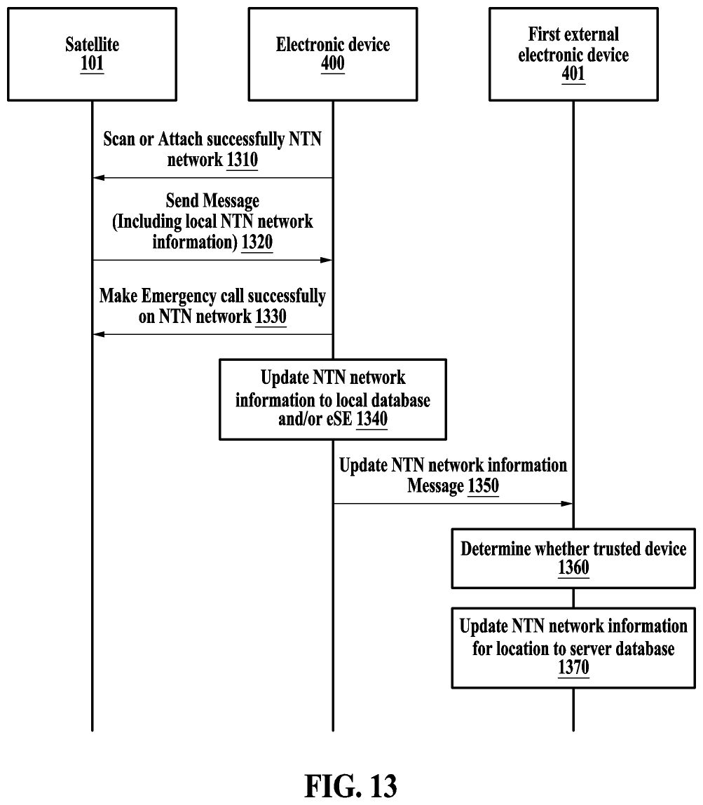

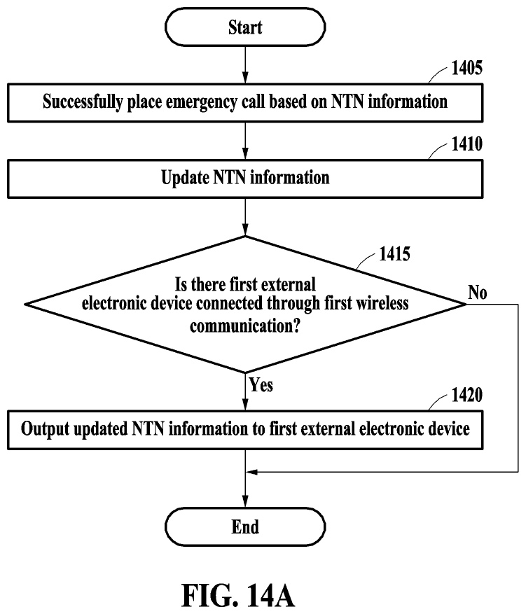

In operation 750, the electronic device 400 may obtain NTN information from an external electronic device (e.g., the first external electronic device 401 of FIG. 4A and/or the second external electronic device 402 of FIG. 4A). The electronic device 400 may output (or transmit) an NTN information request message (e.g., a message related to a request for NTN information) to the external electronic device. When the first external electronic device 401 connected to the electronic device 400 (e.g., connected through a first wireless communication scheme (e.g., the Internet)) is present, the electronic device 400 may output the NTN information request message to the first external electronic device 401. When the first external electronic device 401 connected to the electronic device 400 is absent, the electronic device 400 may output the NTN information request message to the second external electronic device 402. A method of outputting an NTN information request message to the first external electronic device 401 is described in greater detail below with reference to FIGS. 12 and 13. A method of outputting an NTN information request message to the second external electronic device 402 is described in greater detail below with reference to FIGS. 10A and 10B.

According to an embodiment, the external electronic device may output NTN information to the electronic device 400 based on the NTN information request message. For example, the first external electronic device 401 may be a server that is responsible for supporting (e.g., storing and/or providing NTN information) an NTN connection. The first external electronic device 401 may output stored NTN information to the electronic device 400. For example, like the electronic device 400, the second external electronic device 402 may be a user terminal. The second external electronic device 402 may or may not store NTN information. For example, the second external electronic device 402 may not necessarily store NTN information at a predetermined location (e.g., a location corresponding to NTN information requested by the electronic device 400). When storing NTN information, the second external electronic device 402 may output the stored NTN information to the electronic device 400. When not storing NTN information, the second external electronic device 402 may obtain NTN information from a separate external electronic device (e.g., a third external electronic device and/or a fourth external electronic device) and output the obtained NTN information to the electronic device 400. A method by which the second external electronic device 402 outputs NTN information to the electronic device 400 is described in greater detail below with reference to FIG. 11A.

In operation 770, the electronic device 400 may determine whether an emergency call is supported through a TN. An issue (e.g., an issue that the electronic device 400 loses a connection with a base station that supports a TN) may occur with a connection through the TN at a predetermined location. In this case, the electronic device 400 may not be able to support an emergency call through the TN. When the electronic device 400 may not support an emergency call through the TN, the electronic device 400 may perform operation 790 to search for another network (e.g., an NTN) that supports an emergency call.

In operation 790, based on NTN information, the electronic device 400 may search for an NTN according to a priority order related to an NTN connection. The electronic device 400 may activate an NTN setting mode based on the NTN information. Activation of an NTN setting mode is described in greater detail above in operation 550 of FIG. 5, so any duplicate description may not be repeated here.

According to an embodiment, when an NTN setting mode is activated, the electronic device 400 may search for an NTN according to a priority order related to an NTN connection. Based on the priority order, the electronic device 400 may determine which NTN to connect to first among a plurality of NTNs. The priority order related to the NTN connection may be determined based on a requirement for an emergency call, a recent connection time between the electronic device 400 and an NTN, the number of connections between an external electronic device and an NTN, and/or the quality of service (QoS) of the connection between the electronic device 400 and the NTN. Hereinafter, each element is described in greater detail.

According to an embodiment, the electronic device 400 may first search for an NTN based on the recent connection time between the electronic device 400 and the NTN. For example, the electronic device 400 may preferentially attempt to establish a connection with the most recently connected NTN.

According to an embodiment, the electronic device 400 may first search for an NTN based on the number of connections between the external electronic device and the NTN. For example, the electronic device 400 may preferentially attempt to establish a connection with the NTN based on the number of connections between the external electronic device (e.g., the second external electronic device 402) and the NTN and its reliability. NTN information obtained from a frequently connected external electronic device may be considered reliable.

According to an embodiment, the electronic device 400 may first search for the NTN based on the QoS of the connection between the electronic device 400 and the NTN. For example, a physical distance and/or signal strength between the electronic device 400 and a component (e.g., the satellite 101 of FIG. 1) of the NTN may be an important factor in determining a priority order. The electronic device 400 may set a priority order according to a service provided by the NTN. For example, the electronic device 400 may preferentially select an NTN with a strong signal strength and a close physical distance. When a predetermined NTN provides a faster transmission speed or lower latency, the predetermined NTN may be preferentially selected.

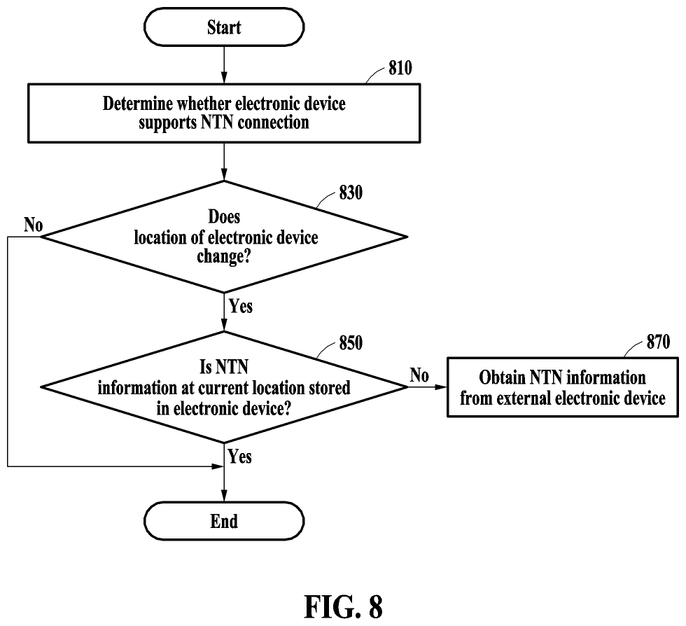

FIG. 8 is a flowchart illustrating an example method of verifying validity of NTN information in order to request NTN information from an external electronic device, according to various embodiments.

Referring to FIG. 8, operations 810 to 870 may be performed sequentially but not necessarily. For example, operations 810 to 870 may be performed in different orders, and at least two operations may be performed in parallel.

In operation 810, an electronic device (e.g., the terminal 102 of FIG. 1 and/or the electronic device 400 of FIG. 4A) may determine whether the electronic device 400 supports an NTN connection. Operation 810 is substantially the same as operation 710 of FIG. 7, so any duplicate description may not be repeated here.

In operation 830, the electronic device 400 may determine whether the location of the electronic device 400 is changed. For example, as the location of the electronic device 400 is changed (e.g., a change from a previous location to a current location), an NTN connection may not be established at the current location through existing NTN information (e.g., NTN information for establishing an NTN connection at the previous location). When the location of the electronic device 400 is changed (e.g., when the existing NTN information may not be used as the location of the electronic device 400 is changed), the electronic device 400 may perform operation 850. When the location of the electronic device 400 is not changed (e.g., when the existing NTN information may be used as the location of the electronic device 400 is not changed), the electronic device 400 may terminate the operation.

In operation 850, the electronic device 400 may determine whether NTN information (e.g., NTN information that is different from the existing NTN information) at the current location is stored in the electronic device 400. The electronic device 400 may determine whether the NTN information at the current location is stored in one or more of memory (e.g., the memory 430 of FIG. 4B) included in the electronic device 400 and/or an eSIM included in the electronic device 400. When the NTN information at the current location is stored in the electronic device 400, the electronic device 400 may terminate the operation. When the NTN information at the current location is not stored in the electronic device 400, the electronic device 400 may perform operation 870. However, even when the NTN information at the current location is stored in the electronic device 400, when the validity period of the NTN information at the current location expires, the electronic device 400 may perform operation 870.

In operation 870, the electronic device 400 may obtain NTN information from an external electronic device (e.g., the first external electronic device 401 of FIG. 4A and/or the second external electronic device 402 of FIG. 4A). A method of obtaining NTN information is described in greater detail below with reference to FIG. 9.

FIG. 9 is a flowchart illustrating an example method of requesting NTN information from an external electronic device, according to various embodiments.

Referring to FIG. 9, operations 910 to 960 may be performed sequentially but not necessarily. For example, operations 910 to 960 may be performed in different orders, and at least two operations may be performed in parallel.

In operation 910, an electronic device (e.g., the terminal 102 of FIG. 1 and/or the electronic device 400 of FIG. 4A) may determine whether an external electronic device (e.g., the first external electronic device 401 of FIG. 4A) connected through first wireless communication is present. When the first external electronic device 401 is present, the electronic device 400 may perform operation 920. When the first external electronic device 401 is absent, the electronic device 400 may perform operation 940.

In operation 920, the electronic device 400 may output an NTN information request message to the first external electronic device 401 (e.g., a server responsible for supporting (e.g., storing and/or providing NTN information) an NTN connection). The electronic device 400 may output the NTN information request message through a hypertext transfer protocol get (HTTP GET) request. The HTTP GET request may be a request used to obtain (e.g., read or retrieve data) data from a server (e.g., the first external electronic device 401).

In operation 930, the electronic device 400 may determine whether NTN information is obtained from the first external electronic device 401. Based on the NTN information request message, the first external electronic device 401 may output a response message (e.g., including NTN information) to the electronic device 400. When the HTTP GET request is successfully made, the first external electronic device 401 may output an HTTP response code (e.g., HTTP 200 (OK)) (e.g., a response message) to the electronic device 400. However, when the HTTP GET request fails, the first external electronic device 401 may output a response message to the electronic device 400. When obtaining the NTN information from the first external electronic device 401, the electronic device 400 may perform operation 960. When obtaining the NTN information from the first external electronic device 401, the electronic device 400 may perform operation 940.

In operation 940, the electronic device 400 may output the NTN information request message to a second external electronic device (e.g., the second external electronic device 402 of FIG. 4A) (e.g., a user terminal near the electronic device 400). For example, the electronic device 400 may be connected to the second external electronic device 402 through BLE. The electronic device 400 may output the NTN information request message to the second external electronic device 402 through a link layer packet of BLE. This is described in greater detail below with reference to FIG. 10B.

In operation 950, the electronic device 400 may determine whether NTN information is obtained from the second external electronic device 402. Based on the NTN information request message, the second external electronic device 402 may output a response message (e.g., including NTN information) to the electronic device 400. The second external electronic device 402 may output a response message through the link layer packet of BLE to the electronic device 400 in the same way as the NTN information request message is output.

In operation 960, the electronic device 400 may store NTN information (e.g., NTN information at the current location of the electronic device 400). For example, the electronic device 400 may store the NTN information in memory of the electronic device 400 and/or an eSIM of the electronic device 400.

FIGS. 10A and 10B are a signal flow diagram and diagram, respectively, illustrating an example method of transmitting and receiving data between an electronic device and a second external electronic device according to various embodiments.

Referring to FIG. 10A, operations 1010 and 1020 may be performed sequentially but not necessarily. For example, operations 1010 and 1020 may be performed in different orders, and at least two operations may be performed in parallel.

In operation 1010, an electronic device (e.g., the terminal 102 of FIG. 1 and/or the electronic device 400 of FIG. 4A) may transmit (or output) an NTN information request message to a second external electronic device (e.g., the second external electronic device 402 of FIG. 4A) (e.g., a user terminal near the electronic device 400). The electronic device 400 may be connected to the second external electronic device 402 through a second wireless communication scheme (e.g., BLE). The NTN information request message transmitted to the second external electronic device 402 may be a message transmitted through the second wireless communication scheme.

Referring to FIG. 10A, according to an embodiment, the electronic device 400 may generate an NTN information request message by adding an NTN code (e.g., NTN information request) to a link layer packet 1030 of BLE. The electronic device 400 may add the NTN code to a portion (e.g., a protocol data unit (PDU) 1040) of the link layer packet 1030. The PDU 1040 may include a header 1050 for data transmission. The electronic device 400 may transmit the link layer packet 1030 to which the NTN code is added to the second external electronic device 402.

In operation 1020, the second external electronic device 402 may output a response message to the electronic device 400. The response message may include NTN information. The response message may be a message transmitted through the second wireless communication scheme. The response message may be generated in substantially the same way as the NTN information request message described with reference to FIG. 10A. For example, the NTN information may be added to a portion (e.g., the PDU 1040) of the link layer packet 1030 and transmitted to the electronic device 400. Accordingly, a repeated description thereof is omitted.

FIG. 11A is a flowchart illustrating an example operation in which a second external electronic device outputs NTN information to an electronic device, according to various embodiments.

Referring to FIG. 11A, operations 1105 to 1140 may be performed sequentially but not necessarily. For example, operations 1105 to 1140 may be performed in different orders, and at least two operations may be performed in parallel.

In operation 1105, a second external electronic device (e.g., the second external electronic device 402 of FIG. 4A) may receive an NTN information request message (e.g., a message related to a request for NTN information) from an electronic device (e.g., the terminal 102 of FIG. 1 and/or the electronic device 400 of FIG. 4A). The second external electronic device 402 may be connected to the electronic device 400 through a second wireless communication scheme (e.g., BLE). The second external electronic device 402 may receive a data packet (e.g., the link layer packet 1030 of FIG. 10B) including an NTN information request (e.g., an NTN code). This is described in greater detail with reference to FIGS. 10A and 10B, so any repeated description thereof is not provided here.

In operation 1110, the second external electronic device 402 may determine whether there is NTN information. For example, the second external electronic device 402 may determine whether NTN information is stored in a predetermined location (e.g., the location of NTN information requested by the electronic device 400) of memory and/or an eSIM of the second external electronic device 402. When there is the NTN information, the second external electronic device 402 may perform operation 1140. When there is no NTN information, the second external electronic device 402 may perform operation 1115.

In operation 1115, the second external electronic device 402 may determine whether an external electronic device (e.g., a third external electronic device (not shown)) connected through a first wireless communication scheme (e.g., the Internet) is present. The third external electronic device may perform substantially the same role as a first external electronic device (e.g., the first external electronic device 401 of FIG. 4A). For example, the third external electronic device may be a server that is responsible for supporting (e.g., storing and/or providing NTN information) an NTN connection. The third external electronic device may be implemented as a different server from the first external electronic device 401. However, embodiments are not limited thereto, and the third external electronic device may be the same server as the first external electronic device 401. When there is the third external electronic device, the second external electronic device 402 may perform operation 1120. When there is no third external electronic device, the second external electronic device 402 may perform operation 1125.

In operation 1120, the second external electronic device 402 may output the NTN information request message to the third external electronic device. The second external electronic device 402 may output the NTN information request message to the third external electronic device in substantially the same way as operation 920 of FIG. 9. For example, the second external electronic device 402 may output the NTN information request message through an HTTP GET request.

In operation 1125, the second external electronic device 402 may determine whether an external electronic device (e.g., a fourth external electronic device) connected through a second wireless communication scheme (e.g., BLE, Wi-Fi Direct, or Nearby Share) is present. The relationship between the fourth external electronic device and the second external electronic device 402 may be substantially the same as the relationship between the electronic device 400 and the second external electronic device 402. For example, like the second external electronic device 402, the fourth external electronic device 402 may be a user terminal. The fourth external electronic device may store and/or provide NTN information. However, when not storing NTN information, the fourth external electronic device may request NTN information from another external electronic device and provide the NTN information to the second external electronic device 402. For example, when not connected to the third external electronic device (e.g., a server responsible for supporting an NTN connection), the second external electronic device 402 may determine whether the second external electronic device 402 may be connected to another user terminal near (e.g., within a predetermined range) the second external electronic device 402. When there is no fourth external electronic device, the second external electronic device 402 may terminate the operation. When there is the fourth external electronic device, the second external electronic device 402 may perform operation 1130.

In operation 1130, the second external electronic device 402 may output the NTN information request message to the fourth external electronic device. The second external electronic device 402 may be connected to the fourth external electronic device through a BLE scheme. The second external electronic device 402 may output a data packet (e.g., the link layer packet 1030 of FIG. 10B) including the NTN information request (e.g., an NTN code) to the fourth external electronic device. This may be substantially the same as how the electronic device 400 outputs an NTN information request message to the second external electronic device 402.

In operation 1135, the second external electronic device 402 may determine whether NTN information is obtained.

According to an embodiment, when the NTN information request message is output to the third external electronic device through the HTTP GET request and the HTTP GET request is successfully made, the second external electronic device 402 may receive an HTTP response code (e.g., HTTP 200 (OK)) (e.g., a response message) from the third external electronic device. The HTTP response code may include NTN information. For example, when the HTTP GET request is successful, the second external electronic device 402 may obtain (e.g., receive) the NTN information from the third external electronic device. On the other hand, when the HTTP GET request fails, the second external electronic device 402 may not obtain the NTN information from the third external electronic device. The method of transmitting and receiving data (e.g., an NTN information request and/or NTN information) between the second external electronic device 402 and the third external electronic device may be substantially the same as the method of transmitting and receiving data between the electronic device 400 and the first external electronic device 401.

According to an embodiment, when the data packet (e.g., the link layer packet 1030 of FIG. 10B) including the NTN information (e.g., an NTN code) is output to the fourth external electronic device and the NTN information request is successfully made, the second external electronic device 402 may receive a response message (e.g., including the NTN information) (e.g., the link layer packet 1030 in which the NTN information is added to a portion (e.g., the PDU 1040)) from the fourth external electronic device. For example, when the NTN information request is successful, the second external electronic device 402 may obtain (e.g., receive) the NTN information from the fourth external electronic device. On the other hand, when the NTN information request fails, the second external electronic device 402 may not obtain the NTN information from the fourth external electronic device. The method of transmitting and receiving data (e.g., an NTN information request and/or NTN information) between the second external electronic device 402 and the fourth external electronic device may be substantially the same as the method of transmitting and receiving data between the electronic device 400 and the second external electronic device 402.

According to an embodiment, when obtaining the NTN information from an external electronic device (e.g., the third external electronic device and/or the fourth external electronic device), the second external electronic device 402 may perform operation 1140. When failing to obtain the NTN information from the external electronic device, the second external electronic device 402 may terminate the operation. A case in which the external electronic device terminates the operation due to failure to obtain the NTN information from the external electronic device may correspond to a case in which the NTN information request output from the electronic device 400 to the second external electronic device 402 fails.

In operation 1140, the second external electronic device 402 may output the NTN information to the electronic device 400. As described in operation 1020 of FIG. 10A, the second external electronic device 402 may output a response message (e.g., including the NTN information) to the electronic device 400.

FIG. 11B is a flowchart illustrating an example operation in which the electronic device obtains the NTN information from the second external electronic device and updates memory, according to various embodiments.

Referring to FIG. 11B, operations 1145 to 1170 may be performed sequentially but not necessarily. For example, operations 1145 to 1170 may be performed in different orders, and at least two operations may be performed in parallel.

In operation 1145, the electronic device (e.g., the terminal 102 of FIG. 1 and/or the electronic device 400 of FIG. 4A) may turn on a second wireless communication protocol. The electronic device 400 may be connected to the second external electronic device (e.g., the second external electronic device 402 of FIG. 4A) through a second wireless communication scheme (e.g., BLE, Wi-Fi Direct, and/or Nearby Share) by turning on the second wireless communication protocol.

In operation 1150, the electronic device 400 may output an NTN information request message (e.g., a message related to a request for NTN information) to the second external electronic device 402. For example, the electronic device 400 may be connected to the second external electronic device 402 through a BLE scheme. The electronic device 400 may output a data packet (e.g., the link layer packet 1030 of FIG. 10B) to which an NTN code (e.g., an NTN information request) is added to the second external electronic device 402. This is described in detail with reference to FIGS. 10A and 10B, so any repeated description thereof is omitted.

In operation 1155, the electronic device 400 may determine whether a connection time with the second external electronic device 402 expires. When the connection time expires, the electronic device 400 may perform operation 1160. When the connection time does not expire, the electronic device 400 may perform operation 1150 and continuously output the NTN information request message to the second external electronic device 402.

In operation 1160, the electronic device 400 may turn off the second wireless communication protocol. When the connection time with the second external electronic device 402 expires, the electronic device 400 may terminate a connection with the second external electronic device 402 by turning off the second wireless communication protocol.

In operation 1165, the electronic device 400 may determine whether NTN information is obtained. During the connection time with the second external electronic device 402, the electronic device 400 may determine whether the NTN information is obtained from the second external electronic device 402. For example, before the connection time expires, the electronic device 400 may output the NTN information request to the second external electronic device 402 through operation 1150. The second external electronic device 402 may transmit the NTN information to the electronic device 400 before the connection time expires. However, as described with reference to FIG. 11A, the second external electronic device 402 may also fail to obtain the NTN information and thus may not be able to transmit the NTN information to the electronic device 400.

According to an embodiment, when obtaining the NTN information from the second external electronic device 402, the electronic device 400 may perform operation 1170. When failing to obtain the NTN information from the second external electronic device 402, the electronic device 400 may terminate the operation.

In operation 1170, the electronic device 400 may update memory (e.g., the memory 430 of FIG. 4B). The electronic device 400 may store the obtained NTN information in the memory 430. The electronic device 400 may store the NTN information in an eSIM as well as in the memory 430.

FIG. 12 is a signal flow diagram illustrating an example method of transmitting and receiving data between an electronic device and a first external electronic device, according to various embodiments.

Referring to FIG. 12, operations 1205 and 1210 may be performed sequentially but not necessarily. For example, operations 1205 to 1210 may be performed in different orders, and at least two operations may be performed in parallel.

In operation 1205, when NTN information at a current location is invalid, an electronic device (e.g., the terminal 102 of FIG. 1 and/or the electronic device 400 of FIG. 4A) may output an NTN information request message (e.g., a message related to a request for NTN information) to a first external electronic device (e.g., the first external electronic device 401 of FIG. 4A). For example, the electronic device 400 may be connected to the external electronic device 401 over the Internet. The electronic device 400 may output the NTN information request message to the first external electronic device 401 through an HTTP protocol. The electronic device 400 may transmit the NTN information request message to the first external electronic device 401 through an HTTP GET request.

In operation 1210, based on the NTN information request message, the first external electronic device 401 may output a response message to the electronic device 400. Based on the NTN information request message, the first external electronic device 401 may output a response message (e.g., including NTN information) to the electronic device 400. When the HTTP GET request is successfully made, the first external electronic device 401 may output an HTTP response code (e.g., HTTP 200 (OK)) (e.g., a response message) to the electronic device 400. However, when the HTTP GET request fails, the first external electronic device 401 may output a response message to the electronic device 400.

FIG. 13 is a signal flow diagram illustrating an example method of updating NTN information, according to various embodiments.

Referring to FIG. 13, operations 1310 to 1370 may be performed sequentially but not necessarily. For example, the order of operations 1310 to 1370 may be changed, and at least two of operations 1310 to 1370 may be performed in parallel.

In operation 1310, an electronic device (e.g., the terminal 102 of FIG. 1 and/or the electronic device 400 of FIG. 4A) may search for and/or access (or may be connected to) an NTN for communicating with a satellite (e.g., the satellite 101 of FIG. 1). As described with reference to FIGS. 1 to 12, the electronic device 400 may obtain NTN information from an external electronic device (e.g., the first external electronic device 401 of FIG. 4A and/or the second external electronic device 402 of FIG. 4A). Based on the obtained NTN information, the electronic device 400 may search for and/or access (or may be connected to) an NTN.

In operation 1320, the satellite 101 may transmit a message including local NTN information to the electronic device 400. The local NTN information may be information specialized in an NTN connection at a predetermined location (e.g., a location when the electronic device 400 is connected to the satellite 101). For example, the local NTN information may include weather information, geographical data, location information of the electronic device 400, and the like at a predetermined location. The local NTN information may be used to improve or optimize the quality of a communication service at a predetermined location. For example, in operation 1310, the NTN information received from the external electronic device by the electronic device 400 may not include such local NTN information. The electronic device 400 may obtain the local NTN information from the satellite 101 and update the NTN information received from the external electronic device.

According to an embodiment, the satellite 101 may transmit local NTN information to the electronic device 400 via a message (e.g., a sim card command, a registration accept message, and/or a tracking area update accept message) defined in the 3rd-generation partnership project (3GPP) standards related to an NTN.

In operation 1330, the electronic device 400 may successfully place an emergency call through an NTN formed with the satellite 101.

In operation 1340, the electronic device 400 update NTN information (e.g., NTN information received from an external electronic device) stored in memory (e.g., the memory 430 of FIG. 4B) (e.g., a local database) of the electronic device and/or an eSIM of the electronic device. For example, the electronic device 400 may add the local NTN information to the NTN information received from the external electronic device and generate updated NTN information. The electronic device 400 may store the updated NTN information in the memory 430.

In operation 1350, the electronic device 400 may transmit the updated NTN information (e.g., the NTN information reflecting the local NTN information) to the first external electronic device 401. For example, the electronic device 400 may be connected to the external electronic device 401 over the Internet. The electronic device 400 may transmit the updated NTN information to the first external electronic device 401 through an HTTP protocol. The electronic device 400 may transmit the updated NTN information through an HTTP post scheme and/or an HTTP put scheme.

In operation 1360, the first external electronic device 401 may verify the reliability of the electronic device 400. The first external electronic device 401 may verify the reliability of the electronic device 400 based on a preset criterion (e.g., authentication, certificate verification, integrity verification of the electronic device 400 through a trusted platform module (TPM), a network connection state, log monitoring of the electronic device 400, and/or security state evaluation). When the electronic device 400 is reliable, the first external electronic device 401 may perform operation 1370.

In operation 1370, the first external electronic device 401 may store the updated NTN information in memory (or a database) of the first external electronic device 401. Accordingly, when there is an NTN information request from a predetermined location (e.g., the location of the local NTN information reflected in the updated NTN information) from the electronic device 400 and/or another electronic device, the first external electronic device 401 may transmit the updated NTN information. This is described in greater detail below with reference to FIG. 14B.

FIGS. 14A and 14B are flowcharts illustrating an example method of updating the NTN information illustrated in FIG. 13 through operations of an electronic device and a first external electronic device according to various embodiments. FIG. 14A illustrates operations of the electronic device 400, and FIG. 14B illustrates operations of the first external electronic device.

Referring to FIG. 14A, operations 1405 to 1420 may be performed sequentially but not necessarily. For example, the order of operations 1405 to 1420 may be changed, and at least two of operations 1405 to 1420 may be performed in parallel.

In operation 1405, the electronic device (e.g., the terminal 102 of FIG. 1 and/or the electronic device 400 of FIG. 4A) may successfully place an emergency call based on NTN information (e.g., NTN information at a current location of the electronic device 400 when a request for NTN information is transmitted to an external electronic device (e.g., the first external electronic device 401 of FIG. 4A and/or the second external electronic device 402 of FIG. 4A)). For example, based on the NTN information, the electronic device 400 may search for an NTN that supports an emergency call according to a priority order related to an NTN connection. The electronic device 400 may attempt to establish an NTN connection with the highest priority. The electronic device 400 may be connected to an NTN.

In operation 1410, the electronic device 400 may update the NTN information. For example, as described in operations 1310 to 1330 of FIG. 13, the electronic device 400 may obtain local NTN information from the connected NTN. The electronic device 400 may update existing NTN information by reflecting the local NTN information in the existing NTN information.

In operation 1415, the electronic device 400 may determine whether the first external electronic device 401 (e.g., a server responsible for supporting (e.g., storing and/or providing NTN information) an NTN connection) connected through a first wireless communication scheme (e.g., the Internet) is present. When the first external electronic device 401 connected to the electronic device 400 is present, the electronic device 400 may perform operation 1420. When the first external electronic device 401 connected to the electronic device 400 is absent, the electronic device 400 may terminate the operation.

In operation 1420, the electronic device 400 may output the updated NTN information to the first external electronic device 401. Since the electronic device 400 is connected to the first external electronic device 401 through the first wireless communication scheme, the electronic device 400 may transmit the updated NTN information to the first external electronic device 401 through an HTTP protocol. This is described in greater detail in operation 1350 of FIG. 13, and any duplicate description is not repeated here.

Referring to FIG. 14B, operations 1425 to 1450 may be performed sequentially but not necessarily. For example, the order of operations 1425 to 1450 may be changed, and at least two of operations 1425 to 1450 may be performed in parallel.

In operation 1425, the first external electronic device (e.g., the first external electronic device 401 of FIG. 4A) may receive the updated NTN information. Since the first external electronic device 401 is connected to the electronic device (e.g., the terminal 102 of FIG. 1 and/or the electronic device 400 of FIG. 4A) through the first wireless communication scheme (e.g., the Internet), the first external electronic device may receive the updated NTN information through the HTTP protocol.

In operation 1430, the first external electronic device 401 may evaluate the reliability of the electronic device 400. Based on a preset (e.g., specified) reliability evaluation criterion, the first external electronic device 401 may evaluate the reliability of the electronic device 400. This is described in greater detail in operation 1360 of FIG. 13, and any duplicate description is not repeated here.

According to an embodiment, when the electronic device 400 is reliable, the first external electronic device 401 may perform operation 1435. When the electronic device 400 is unreliable, the first external electronic device 401 may terminate operation 1435.

In operation 1435, the first external electronic device 401 may update memory of the first external electronic device 401. The first external electronic device 401 may store data (e.g., updated NTN information) received from a reliable device (e.g., the electronic device 400) in memory.

In operation 1440, the first external electronic device 401 may receive an NTN information request message at a predetermined location from an electronic device (e.g., including other electronic devices other than the electronic device 400). The electronic device 400 has the updated NTN information at the predetermined location, so the first external electronic device 401 may receive the NTN information request message at the predetermined location from an electronic device that does not have the updated NTN information at the predetermined location. The first external electronic device 401 may be a server responsible for supporting an NTN connection and may be connected to an electronic device over the Internet. The first external electronic device 401 may receive the NTN information request message through an HTTP GET request.

According to an embodiment, when failing to receive the NTN information request message from an electronic device, the first external electronic device 401 may terminate the operation. When receiving the NTN information request message from the electronic device, the first external electronic device 401 may perform operation 1445.

In operation 1445, the first external electronic device 401 may determine whether the requested NTN information is stored in memory. For example, in operation 1435, an electronic device (e.g., an electronic device that is different from the electronic device 400 and that does not have NTN information) may request the updated NTN information stored in the memory. The first external electronic device 401 may determine that there is the updated NTN information for a predetermined location. For example, the location of the electronic device 400 may be changed. The electronic device 400 may perform an NTN connection at the changed location through the updated NTN information for the predetermined location. That is, the electronic device 400 may transmit a request for the NTN information for the changed location to the first external electronic device for establishing an NTN connection at the changed location. In this case, the first external electronic device 401 may determine whether the NTN information for the changed location is stored in memory.

According to an embodiment, when the requested NTN information is stored in the memory, the first external electronic device 401 may perform operation 1450. When the requested NTN information is not stored in the memory, the first external electronic device 401 may terminate the operation. For example, when the electronic device 400 transmits the request for the NTN information for the changed location to the first external electronic device 401 but the first external electronic device 401 does not have the NTN information for the changed location, the electronic device 400 may output an NTN information request message for the changed location to the second external electronic device (e.g., the second external electronic device 402 of FIG. 4A). This is described in detail in operation 930 of FIG. 9, and any duplicate description is omitted.

In operation 1450, when having the requested NTN information, the first external electronic device 401 may output the NTN information to the electronic device. Since the first external electronic device 401 receives the message from the electronic device through the HTTP GET request in operation 1440, the first external electronic device 401 may output an HTTP response code (e.g., HTTP 200 (OK)) (e.g., a response message) to the electronic device 400. The HTTP response code may include the requested NTN information.

FIG. 15 is a flowchart illustrating an example method of placing an emergency call when an electronic device obtains NTN information from an external electronic device, according to various embodiments.

Referring to FIG. 15, operations 1510 to 1590 may be performed sequentially but not necessarily. For example, the order of operations 1510 to 1590 may be changed, and at least two of operations 1510 to 1590 may be performed in parallel.

In operation 1510, when a TN (e.g., a cellular network and/or a Wi-Fi network) supports an emergency call, an electronic device (e.g., the terminal 102 of FIG. 1 and/or the electronic device 400 of FIG. 4A) may preferentially place an emergency call through the TN. When successfully placing an emergency call through the TN, the electronic device 400 may terminate the operation.

According to an embodiment, when failing to place an emergency call through the TN, the electronic device 400 may place an emergency call through an NTN. However, in order to place an emergency call through the NTN, an NTN connection may be required to be established. When failing to placing an emergency call through the TN, the electronic device 400 may perform operation 1530 to establish an NTN connection to place an emergency call through the NTN.

In operation 1530, the electronic device 400 may determine whether there is NTN information at the current location of the electronic device 400. When there is no NTN information at the current location, the electronic device 400 may terminate the operation and, as described in operations 850 and 870 of FIG. 8, obtain NTN information from an external electronic device (e.g., the first external electronic device 401 of FIG. 4A and/or the second external electronic device 402 of FIG. 4A). When there is the NTN information at the current location, the electronic device 400 may perform operation 1550.

In operation 1550, the electronic device 400 may turn off a TN connection and turn on an NTN connection. The electronic device 400 may first turn off the TN to establish an NTN connection. Based on the NTN information at the current location, the electronic device 400 may search for an NTN according to a priority order related to an NTN connection. The electronic device 400 may attempt to establish an NTN connection with the highest priority. When an attempt to connect to an NTN with the highest priority fails, the electronic device 400 may attempt to connect to the NTN with the highest priority again and also attempt to connect to an NTN with the next highest priority.

In operation 1570, the electronic device 400 may place an emergency call through the NTN. The emergency call placed through the NTN connection in operation 1550 may fail due to a network issue and the like. When the emergency call fails, the electronic device 400 may perform operation 1550 again and attempt to connect to another NTN that supports an emergency call. When successfully placing an emergency call, the electronic device 400 may perform operation 1590.

In operation 1590, the electronic device 400 may turn off the NTN connection and turn on the TN connection. Since the electronic device 400 places the emergency call in operation 1570, the electronic device 400 may turn off the NTN connection to return to the original state. The electronic device 400 may turn off the NTN connection and then attempt to connect to a cellular network and/or a Wi-Fi network.

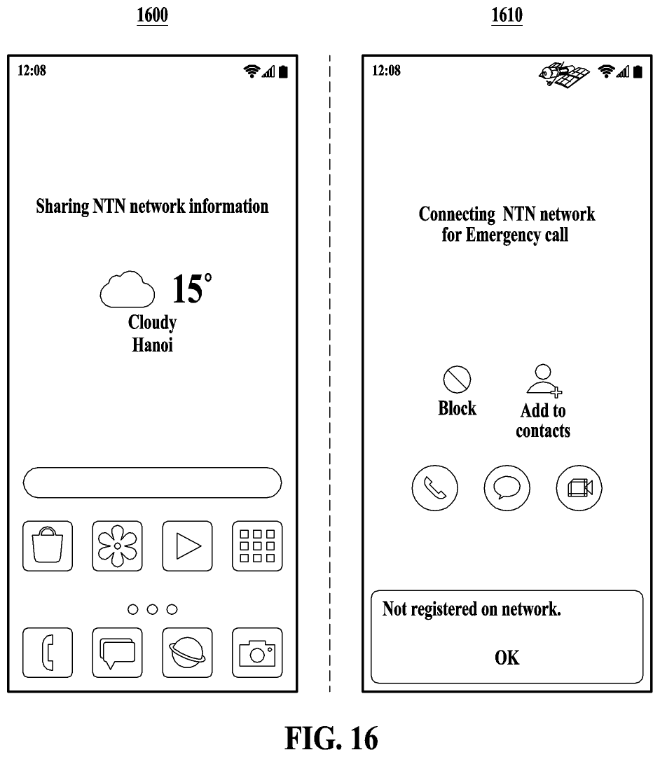

FIG. 16 is a diagram illustrating an example of a screen displaying an NTN information request and an NTN search, according to various embodiments.

Referring to FIG. 16, according to an embodiment, when NTN information at a current location is invalid (e.g., when the NTN information at the current location is absent from the electronic device 400 and/or when the validity period of the NTN information expires even when the NTN information at the current location is present in the electronic device 400), an electronic device (e.g., the terminal 102 of FIG. 1 and/or the electronic device 400 of FIG. 4A) may transmit a request for NTN information to an external electronic device (e.g., the first external electronic device 401 of FIG. 4A and/or the second external electronic device 402 of FIG. 4A). The electronic device 400 may output a screen 1600 to inform a user that a request for NTN information is transmitted to an external electronic device.

According to an embodiment, the electronic device 400 may obtain (e.g., receive) NTN information from the external electronic device and search for an NTN that supports an emergency call based on the NTN information. The electronic device 400 may output a screen 1610 to inform the user that a search for an NTN is being conducted to place an emergency call.

According to an embodiment, not only text (e.g., “Sharing NTN network information” and/or “Connecting NTN network for Emergency call”) but also images showing a request for NTN information and/or a search for an NTN may be added to the screen 1600 and the screen 1610. In addition, the electronic device 400 may not only output the screen 1600 and the screen 1610 but may also provide an auditory notification to the user. There are many ways to provide a notification the user, including visual and auditory notifications.

FIG. 17 is a block diagram illustrating an example electronic device in a network environment, according to various embodiments.

FIG. 17 is a block diagram of an electronic device 1701 in a network environment 1700, according to various embodiments. Referring to FIG. 17, an electronic device 1701 (e.g., the terminal 102 of FIG. 1 and the electronic device 400 of FIG. 4A) in a network environment 1700 may communicate with an electronic device 1702 (e.g., a second external electronic device) via a first network 1798 (e.g., a short-range wireless communication network) or at least one of an electronic device 1704 or a server 1708 (e.g., a first external electronic device) via a second network 1799 (e.g., a long-range wireless communication network). According to an embodiment, the electronic device 1701 may communicate with the electronic device 1704 via the server 1708. According to an embodiment, the electronic device 1701 may include a processor 1720, memory 1730, an input module 1750, a sound output module 1755, a display module 1760, an audio module 1770, a sensor module 1776, an interface 1777, a connecting terminal 1778, a haptic module 1779, a camera module 1780, a power management module 1788, a battery 1789, a communication module 1790, a subscriber information module (SIM) 1796, and/or an antenna module 1797. In an embodiment, at least one of the components (e.g., the connecting terminal 1778) may be omitted from the electronic device 1701, or one or more other components may be added to the electronic device 1701. In an embodiment, some of the components (e.g., the sensor module 1776, the camera module 1780, or the antenna module 1797) may be integrated as a single component (e.g., the display module 1760).

The processor 1720 (e.g., the processor 420 of FIG. 4B) may execute, for example, software (e.g., a program 1740) to control at least one other component (e.g., a hardware or software component) of the electronic device 1701 connected to the processor 1720 and may perform various types of data processing or computation. According to an embodiment, as at least a part of data processing or computation, the processor 1720 may store a command or data received from another component (e.g., the sensor module 1776 or the communication module 1790) in a volatile memory 1732, process the command or the data stored in the volatile memory 1732, and store resulting data in a non-volatile memory 1734.

According to an embodiment, the processor 1720 may be implemented as a system on chip (SoC) or circuitry (e.g., processing circuitry) such as an integrated circuit (IC). The processor 1720 may include one or more processors. For example, the processor 1720 may include a combination of one or more processors, such as a CPU, a GPU, an MPU, an AP, and a CP.

According to an embodiment, the processor 1720 may include the main processor 1721 (e.g., a CPU or an AP), or an auxiliary processor 1723 (e.g., a GPU, a neural processing unit (NPU), an image signal processor (ISP), a sensor hub processor, or a CP) that is operable independently from, or in conjunction with the main processor 1721. For example, when the electronic device 1701 includes the main processor 1721 and the auxiliary processor 1723, the auxiliary processor 1723 may be adapted to consume less power than the main processor 1721 or to be specific to a specified function. The auxiliary processor 1723 may be implemented separately from the main processor 1721 or as a part of the main processor 1721. Thus, the processor 1720 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited /disclosed functions, e.g., in a distributed manner. At least one processor may execute program instructions to achieve or perform various functions.

The auxiliary processor 1723 may control at least some of functions or states related to at least one (e.g., the display module 1760, the sensor module 1776, or the communication module 1790) of the components of the electronic device 1701, instead of the main processor 1721 while the main processor 1721 is in an inactive (e.g., sleep) state or together with the main processor 1721 while the main processor 1721 is in an active state (e.g., executing an application). According to an embodiment, the auxiliary processor 1723 (e.g., an ISP or a CP) may be implemented as a portion of another component (e.g., the camera module 1780 or the communication module 1790) that is functionally related to the auxiliary processor 1723. According to an embodiment, the auxiliary processor 1723 (e.g., an NPU) may include a hardware structure specifically for artificial intelligence (AI) model processing. An AI model may be generated by machine learning. Such learning may be performed by, for example, the electronic device 1701 in which the AI model is performed or performed via a separate server (e.g., the server 1708). A learning algorithm may include, but is not limited to, for example, supervised learning, unsupervised learning, semi-supervised learning, or reinforcement learning. The AI model may include a plurality of artificial neural network layers. An artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network, or a combination of two or more thereof, but is not limited thereto. The AI model may additionally or alternatively include a software structure other than the hardware structure.

The memory 1730 (e.g., the memory 430 of FIG. 4B) may store various pieces of data used by at least one component (e.g., the processor 1720 or the sensor module 1776) of the electronic device 1701. The various pieces of data may include, for example, software (e.g., the program 1740) and input data or output data for a command related thereto.

According to an embodiment, the memory 1730 may include one or more memories. Instructions stored in the memory 1730 may be stored in one memory. The instructions stored in the memory 1730 may be divided and stored in a plurality of memories. The instructions stored in the memory 1730 may be individually or collectively executed by the processor 1720 to cause the electronic device 1701 (e.g., the electronic device 400 of FIG. 4A) to perform and/or control the method of placing an emergency call described with reference to FIGS. 1 to 16. The instructions stored in the memory 1730 may be individually or collectively executed by a plurality of processors to cause the electronic device 1701 (e.g., the electronic device 400 of FIG. 4A) to perform and/or control the method of placing an emergency call described with reference to FIGS. 1 to 16. According to an embodiment, the memory 1730 may include the volatile memory 1732 or the non-volatile memory 1734.

The program 1740 may be stored as software in the memory 1730 and may include, for example, an operating system (OS) 1742, middleware 1744, or an application 1746.

The input module 1750 may receive, from the outside (e.g., a user) of the electronic device 1701, a command or data to be used by a component (e.g., the processor 1720) of the electronic device 1701. The input module 1750 may include, for example, a microphone, a mouse, a keyboard, a key (e.g., a button), or a digital pen (e.g., a stylus pen).

The sound output module 1755 may output a sound signal to the outside of the electronic device 1701. The sound output module 1755 may include, for example, a speaker or receiver. The speaker may be used for general purposes, such as playing multimedia or playing record. The receiver may be used to receive an incoming call. According to an embodiment, the receiver may be implemented separately from the speaker or as a portion of the speaker.

The display module 1760 may visually provide information to the outside (e.g., a user) of the electronic device 1701. The display module 1760 may include, for example, a display, a hologram device, or a projector and control circuitry to control a corresponding one of the display, the hologram device, and the projector. According to an embodiment, the display module 1760 may include a touch sensor adapted to sense a touch or a pressure sensor adapted to measure an intensity of a force incurred by the touch.

The audio module 1770 may convert a sound into an electric signal and vice versa. According to an embodiment, the audio module 1770 may obtain the sound via the input module 1750 or output the sound via the sound output module 1755 or an external electronic device (e.g., the electronic device 1702 such as a speaker or headphones) directly or wirelessly connected to the electronic device 1701.

The sensor module 1776 may detect an operational state (e.g., power or temperature) of the electronic device 1701 or an environmental state (e.g., a state of a user) external to the electronic device 1701 and generate an electrical signal or data value corresponding to the detected state. According to an embodiment, the sensor module 1776 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1777 may support one or more specified protocols to be used for the electronic device 1701 to be coupled with the external electronic device (e.g., the electronic device 1702) directly or wirelessly. According to an embodiment, the interface 1777 may include, for example, a high definition multimedia interface (HDMI), a universal serial bus (USB) interface, a secure digital (SD) card interface, or an audio interface.

The connecting terminal 1778 may include a connector via which the electronic device 1701 may be physically connected to an external electronic device (e.g., the electronic device 1702). According to an embodiment, the connecting terminal 1778 may include, for example, an HDMI connector, a USB connector, an SD card connector, or an audio connector (e.g., a headphone connector).

The haptic module 1779 may convert an electrical signal into a mechanical stimulus (e.g., a vibration or a movement) or an electrical stimulus which may be recognized by a user via his or her tactile sensation or kinesthetic sensation. According to an embodiment, the haptic module 1779 may include, for example, a motor, a piezoelectric element, or an electric stimulator.

The camera module 1780 may capture a still image and moving images. According to an embodiment, the camera module 1780 may include one or more lenses, image sensors, ISPs, or flashes.

The power management module 1788 may manage power supplied to the electronic device 1701. According to an embodiment, the power management module 1788 may be implemented as, for example, at least a part of a power management integrated circuit (PMIC).

The battery 1789 may supply power to at least one component of the electronic device 1701. According to an embodiment, the battery 1789 may include, for example, a primary cell which is not rechargeable, a secondary cell which is rechargeable, or a fuel cell.

The communication module 1790 (e.g., the communication module 410 of FIG. 4B) may support establishing a direct (e.g., wired) communication channel or a wireless communication channel between the electronic device 1701 and an external electronic device (e.g., the electronic device 1702, the electronic device 1704, or the server 1708) and performing communication via the established communication channel. The communication module 1790 may include one or more communication processors that operate independently of the processor 1720 (e.g., an application processor) and support direct (e.g., wired) communication or wireless communication. According to an embodiment, the communication module 1790 may include a wireless communication module 1792 (e.g., a cellular communication module, a short-range wireless communication module, or a global navigation satellite system (GNSS) communication module) or a wired communication module 1794 (e.g., a local area network (LAN) communication module, or a power line communication (PLC) module). A corresponding one of these communication modules may communicate with the external electronic device 1704 via the first network 1798 (e.g., a short-range communication network, such as Bluetooth™, Wi-Fi Direct, or infrared data association (IrDA)) or the second network 1799 (e.g., a long-range communication network, such as a legacy cellular network, a 5G network, a next-generation communication network, the Internet, or a computer network (e.g., a LAN or a wide area network (WAN)). These various types of communication modules may be implemented as a single component (e.g., a single chip) or may be implemented as a plurality of components (e.g., a plurality of chips) separate from each other. The wireless communication module 1792 may identify and authenticate the electronic device 1701 in a communication network, such as the first network 1798 or the second network 1799, using subscriber information (e.g., international mobile subscriber identity (IMSI)) stored in the SIM 1796.

The wireless communication module 1792 may support a 5G network after a 4G network, and next-generation communication technology, for example, new radio (NR) access technology. The NR access technology may support enhanced mobile broadband (eMBB), massive machine type communications (mMTC), or ultra-reliable and low-latency communications (URLLC). The wireless communication module 1792 may support a high-frequency band (e.g., a millimeter wave (mmWave) band) to achieve, e.g., a high data transmission rate. The wireless communication module 1792 may support various technologies for securing performance on a high-frequency band, such as, beamforming, massive multiple-input and multiple-output (MIMO), full dimensional MIMO (FD-MIMO), an array antenna, analog beam-forming, or a large scale antenna. The wireless communication module 1792 may support various requirements specified in the electronic device 1701, an external electronic device (e.g., the electronic device 1704), or a network system (e.g., the second network 1799). According to an embodiment, the wireless communication module 1792 may support a peak data rate (e.g., 20 gigabits per second (Gbps) or more) for implementing eMBB, loss coverage (e.g., 164 decibels (dB) or less) for implementing mMTC, or U-plane latency (e.g., 0.5 milliseconds (ms) or less for each of downlink (DL) and uplink (UL), or a round trip of 1 ms or less) for implementing URLLC.

The antenna module 1797 may transmit or receive a signal or power to or from the outside (e.g., an external electronic device) of the electronic device 1701. According to an embodiment, the antenna module 1797 may include an antenna including a radiating element including a conductive material or a conductive pattern formed in or on a substrate (e.g., a printed circuit board (PCB)). According to an embodiment, the antenna module 1797 may include a plurality of antennas (e.g., array antennas). In such a case, at least one antenna appropriate for a communication scheme used in a communication network, such as the first network 1798 or the second network 1799, may be selected by, for example, the communication module 1790 from the plurality of antennas. The signal or power may be transmitted or received between the communication module 1790 and the external electronic device via the at least one selected antenna. According to an embodiment, another component (e.g., a radio frequency integrated circuit (RFIC)) other than the radiating element may be additionally formed as a part of the antenna module 1797.

According to various embodiments, the antenna module 1797 may form a mmWave antenna module. According to an embodiment, the mmWave antenna module may include a PCB, an RFIC disposed on a first surface (e.g., a bottom surface) of the PCB, or adjacent to the first surface and capable of supporting a designated high-frequency band (e.g., the mmWave band), and a plurality of antennas (e.g., array antennas) disposed on a second surface (e.g., a top or a side surface) of the PCB, or adjacent to the second surface and capable of transmitting or receiving signals of the designated high-frequency band.

At least some of the components described above may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1701 and the external electronic device 1704 via the server 1708 coupled with the second network 1799. Each of the external electronic devices 1702 or 1704 may be a device of the same type as or a different type from the electronic device 1701. According to an embodiment, all or some of operations to be executed by the electronic device 1701 may be executed at one or more external electronic devices (e.g., the external electronic devices 1702 and 1704, and the server 1708). For example, if the electronic device 1701 needs to perform a function or a service automatically, or in response to a request from a user or another device, the electronic device 1701, instead of, or in addition to, executing the function or the service, may request one or more external electronic devices to perform at least part of the function or the service. The one or more external electronic devices receiving the request may perform the at least part of the function or the service requested, or an additional function or an additional service related to the request, and may transfer an outcome of the performing to the electronic device 1701. The electronic device 1701 may provide the outcome, with or without further processing of the outcome, as at least part of a reply to the request. To that end, a cloud computing, distributed computing, mobile edge computing (MEC), or client-server computing technology may be used, for example. The electronic device 1701 may provide ultra low-latency services using, e.g., distributed computing or MEC. In an embodiment, the external electronic device 1704 may include an Internet-of-things (IoT) device. The server 1708 may be an intelligent server using machine learning and/or a neural network. According to an embodiment, the external electronic device 1704 or the server 1708 may be included in the second network 1799. The electronic device 1701 may be applied to intelligent services (e.g., a smart home, a smart city, a smart car, or healthcare) based on 5G communication technology or IoT-related technology.

According to an example embodiment, a method of operating an electronic device (e.g., the terminal 102 of FIG. 1, the electronic device 400 of FIG. 4A, or the electronic device 1701 of FIG. 17) may include: obtaining NTN information from an external electronic device based on whether NTN information for establishing an NTN connection at a current location of the electronic device is valid; and placing an emergency call through an NTN based on the NTN information when a TN does not support the emergency call.

According to an example embodiment, the electronic device may include a wireless communication module (e.g., the wireless communication module 410 of FIG. 4B and the communication module 1790 of FIG. 17) comprising communication circuitry configured to support the NTN connection.

According to an example embodiment, the obtaining the NTN information may include determining whether the NTN information is valid. The obtaining the NTN information may include outputting a message related to a request for the NTN information to the external electronic device based on the NTN information being invalid. The obtaining the NTN information may include receiving the NTN information from the external electronic device.

According to an example embodiment, a case in which the NTN information is invalid may include a case in which the NTN information is not in memory included in the electronic device and a case in which a validity period of the NTN information expires.

According to an example embodiment, the external electronic device may include a first external electronic device (e.g., the first external electronic device 401 of FIG. 4A) and a second external electronic device (e.g., the second external electronic device 402 of FIG. 4A). The first external electronic device may be connected to the electronic device through a first wireless communication scheme. The second external electronic device may be connected to the electronic device through a second wireless communication scheme. The first wireless communication scheme may be a communication scheme having a longer communication distance than the second wireless communication scheme.

According to an example embodiment, the outputting the message related to the request for the NTN information to the external electronic device may include outputting the message related to the request for the NTN information to the first external electronic device based on the first external electronic device connected to the electronic device being present. The outputting the message related to the request for the NTN information to the external electronic device may include outputting the message related to the request for the NTN information to the second external electronic device based on the first external electronic device connected to the electronic device being absent.

According to an example embodiment, based on a third external electronic device connected to the second external electronic device through the first wireless communication scheme being present, the second external electronic device may receive the NTN information from the third external electronic device based on the message related to the request for the NTN information. Based on the third external electronic device connected to the second external electronic device being absent, the second external electronic device may receive the NTN information from a fourth external electronic device connected to the second external electronic device through the second wireless communication scheme based on the message related to the request for the NTN information.

According to an example embodiment, the placing the emergency call through the NTN may include searching for the NTN according to a priority order related to the NTN connection based on the NTN information.

According to an example embodiment, the priority order related to the NTN connection may be determined based on a requirement for the emergency call, a recent connection time between the electronic device and the NTN, the number of connections between the external electronic device and the NTN, and quality of service (QoS) of a connection between the electronic device and the NTN.

According to an example embodiment, the method may include placing the emergency call through the TN based on the TN supporting the emergency call.

According to an example embodiment, an electronic device (e.g., the terminal 102 of FIG. 1, the electronic device 400 of FIG. 4A, or the electronic device 1701 of FIG. 17) may include: a wireless communication module (e.g., the wireless communication module 410 of FIG. 4B and the communication module 1790 of FIG. 17) comprising communication circuitry. The electronic device may include at least one processor (e.g., the processor 420 of FIG. 4B and the processor 1720 of FIG. 17) comprising processing circuitry. The electronic device may include memory (e.g., the memory 430 of FIG. 4B and the memory 1730 of FIG. 17) storing instructions. At least one processor, individually or collectively, may be configured to execute the instructions and to cause the electronic device to: obtain NTN information from an external electronic device based on whether the NTN information for establishing an NTN connection at a current location of the electronic device is valid; and place an emergency call through an NTN based on the NTN information when a TN does not support the emergency call.

According to an example embodiment, the wireless communication module may be configured to support the NTN connection.

According to an example embodiment, at least one processor, individually or collectively, may be configured to cause the electronic device to: determine whether the NTN information is valid; output a message related to a request for the NTN information to the external electronic device based on the NTN information being invalid; and receive the NTN information from the external electronic device.

According to an example embodiment, a case in which the NTN information is invalid may include a case in which the NTN information is absent from memory included in the electronic device and a case in which a validity period of the NTN information expires.

According to an example embodiment, the external electronic device may include a first external electronic device (e.g., the first external electronic device 401 of FIG. 4A) and a second external electronic device (e.g., the second external electronic device 402 of FIG. 4A). The first external electronic device may be connected to the electronic device through a first wireless communication scheme. The second external electronic device may be connected to the electronic device through a second wireless communication scheme. The first wireless communication scheme may be a communication scheme having a longer communication distance than the second wireless communication scheme.

According to an example embodiment, at least one processor, individually or collectively, may be configured to cause the electronic device to: output the message related to the request for the NTN information to the first external electronic device based on the first external electronic device connected to the electronic device being present; and output the message related to the request for the NTN information to the second external electronic device based on the first external electronic device connected to the electronic device being absent.

According to an example embodiment, based on a third external electronic device connected to the second external electronic device through the first wireless communication being present, the second external electronic device may receive the NTN information from the third external electronic device based on the message related to the request for the NTN information; based on the third external electronic device connected to the second external electronic device being absent, the second external electronic device may receive the NTN information from a fourth external electronic device connected to the second external electronic device through the second wireless communication based on the message related to the request for the NTN information.

According to an example embodiment, at least one processor, individually or collectively, may be configured to cause the electronic device to search for the NTN according to a priority order related to the NTN connection based on the NTN information.

According to an example embodiment, the priority order related to the NTN connection may be determined based on a requirement for the emergency call, a recent connection time between the electronic device and the NTN, the number of connections between the external electronic device and the NTN, and QoS of a connection between the electronic device and the NTN.

According to an example embodiment, at least one processor, individually or collectively, may be configured to cause the electronic device to place the emergency call through the TN based on the TN supporting the emergency call.

The electronic device according to various embodiments may be one of various types of electronic devices. The electronic device may include, for example, a portable communication device (e.g., a smartphone), a computer device, a portable multimedia device, a portable medical device, a camera, a wearable device, a home appliance device, or the like. According to an embodiment of the present disclosure, the electronic device is not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related components. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms such as “1^{st},” and “2^{nd},” or “first” and “second” may be used to simply distinguish a corresponding component from another, and do not limit the components in other aspect (e.g., importance or order). It is to be understood that if a component (e.g., a first component) is referred to, with or without the term “operatively” or “communicatively,” as “coupled with,” “coupled to,” “connected with,” or “connected to” another component (e.g., a second component), the component may be coupled with the other component directly (e.g., by wire), wirelessly, or via a third component.

As used in connection with various embodiments of the present disclosure, the term “module” may include a unit implemented in hardware, software, or firmware, or any combination thereof, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1740) including one or more instructions that are stored in a storage medium (e.g., internal memory 1736 or external memory 1738) that is readable by a machine (e.g., the electronic device 1701) For example, a processor (e.g., the processor 1720) of the machine (e.g., the electronic device 1701) may invoke at least one of the one or more instructions stored in the storage medium and execute it. This allows the machine to be operated to perform at least one function according to the at least one instruction invoked. The one or more instructions may include code generated by a compiler or code executable by an interpreter. A machine-readable storage medium may be provided in the form of a non-transitory storage medium. Here, the “non-transitory” storage medium is a tangible device and may not include a signal (e.g., an electromagnetic wave), but this term does not differentiate between where data is semi-permanently stored in the storage medium and where the data is temporarily stored in the storage medium.

According to an embodiment, a method according to various embodiments of the present disclosure may be included and provided in a computer program product. The computer program product may be traded as a product between a seller and a buyer. The computer program product may be distributed in the form of a machine-readable storage medium (e.g., a compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. A method of operating an electronic device, the method comprising:
based on whether non-terrestrial network (NTN) information for establishing an NTN connection at a current location of the electronic device is valid, obtaining the NTN information from an external electronic device; and
based on a TN failing to support an emergency call, based on the NTN information, placing the emergency call through an NTN.

2. The method of claim 1, wherein the electronic device comprises a wireless communication module comprising communication circuitry configured to support the NTN connection.

3. The method of claim 1, wherein the obtaining of the NTN information comprises:
determining whether the NTN information is valid;
based on the NTN information being invalid, outputting a message related to a request for the NTN information to the external electronic device; and
receiving the NTN information from the external electronic device.

4. The method of claim 1, wherein a case in which the NTN information is invalid comprises:
a case in which the NTN information is absent from memory comprised in the electronic device; and
a case in which a validity period of the NTN information expires.

5. The method of claim 1, wherein
the external electronic device comprises a first external electronic device and a second external electronic device,
the first external electronic device is connected to the electronic device through a first wireless communication scheme,
the second external electronic device is connected to the electronic device through a second wireless communication scheme, and
the first wireless communication scheme is a communication scheme with a longer communication distance than the second wireless communication scheme.

6. The method of claim 1, wherein the outputting of the message related to the request for the NTN information to the external electronic device comprises:
based on the first external electronic device connected to the electronic device being present, outputting the message related to the request for the NTN information to the first external electronic device; and
based on the first external electronic device connected to the electronic device being absent, outputting the message related to the request for the NTN information to the second external electronic device.

7. The method of claim 1, wherein
based on a third external electronic device connected to the second external electronic device through the first wireless communication scheme being present, based on the message related to the request for the NTN information, the second external electronic device receives the NTN information from the third external electronic device, and
based on the third external electronic device connected to the second external electronic device being absent, based on the message related to the request for the NTN information, the second external electronic device receives the NTN information from a fourth external electronic device through the second wireless communication scheme.

8. The method of claim 1, wherein the placing of the emergency call through the NTN comprises, based on the NTN information, searching for the NTN according to a priority order related to the NTN connection.

9. The method of claim 1, wherein the priority order related to the NTN connection is determined based on a requirement for the emergency call, a recent connection time between the electronic device and the NTN, a number of connections between the external electronic device and the NTN, and quality of service (QoS) of a connection between the electronic device and the NTN.

10. The method of claim 1, further comprising:
based on the TN supporting the emergency call, placing the emergency call through the TN.

11. An electronic device comprising:
a wireless communication module comprising communication circuitry;
at least one processor comprising processing circuitry; and
memory storing instructions, wherein at least one processor, individually or collectively, is configured to execute the instructions and to cause the electronic device to:
based on whether non-terrestrial network (NTN) information for establishing an NTN connection at a current location of the electronic device is valid, obtain the NTN information from an external electronic device; and
based on a TN failing to support an emergency call, based on the NTN information, place the emergency call through an NTN.

12. The electronic device of claim 11, wherein the wireless communication module is configured to support the NTN connection.

13. The electronic device of claim 11, wherein at least one processor, individually or collectively, is configured to cause the electronic device to:
determine whether the NTN information is valid;
based on the NTN information being invalid, output a message related to a request for the NTN information to the external electronic device; and
receive the NTN information from the external electronic device.

14. The electronic device of claim 13, wherein a case in which the NTN information is invalid comprises:
a case in which the NTN information is absent from memory comprised in the electronic device; and
a case in which a validity period of the NTN information expires.

15. The electronic device of claim 11, wherein:
the external electronic device comprises a first external electronic device and a second external electronic device,
the first external electronic device is configured to be connected to the electronic device through a first wireless communication scheme,
the second external electronic device is configured to be connected to the electronic device through a second wireless communication scheme, and
the first wireless communication scheme is a communication scheme with a longer communication distance than the second wireless communication scheme.

16. The electronic device of claim 11, wherein at least one processor, individually or collectively, is configured to cause the electronic device to:
based on the first external electronic device connected to the electronic device being present, output the message related to the request for the NTN information to the first external electronic device 401; and
based on the first external electronic device connected to the electronic device being absent, output the message related to the request for the NTN information to the second external electronic device.

17. The electronic device of claim 16, wherein
based on a third external electronic device connected to the second external electronic device through the first wireless communication being present, based on the message related to the request for the NTN information, the second external electronic device is configured to receive the NTN information from the third external electronic device, and
based on the third external electronic device connected to the second external electronic device being absent, based on the message related to the request for the NTN information, the second external electronic device is configured to receive the NTN information from a fourth external electronic device through the second wireless communication.

18. The electronic device of claim 11, wherein at least one processor, individually or collectively, is configured to cause the electronic device to, based on the NTN information, search for the NTN according to a priority order related to the NTN connection.

19. The electronic device of claim 18, wherein the priority order related to the NTN connection is determined based on a requirement for the emergency call, a recent connection time between the electronic device and the NTN, a number of connections between the external electronic device and the NTN, and quality of service (QoS) of a connection between the electronic device and the NTN.

20. The electronic device of claim 11, wherein at least one processor, individually or collectively, is configured to cause the electronic device to, based on the TN supporting the emergency call, place the emergency call through the TN.
